(19) United States
(12) Patent Application Publication
(10) Pub. No.: US 2026/0301307 A1
(43) Pub. Date: Oct. 1, 2026

(54) DATA PROCESSING

(71) Applicant: Arm Limited, Cambridge (GB)

(72) Inventors: Daren Croxford, Swaffham Prior (GB); Roberto Lopez Mendez, Cambridge (GB); Mina Ivanova Dimova, Great Shelford (GB); Remy Pottier, Grenoble (FR)

(73) Assignee: Arm Limited, Cambridge (GB)

(21) Appl. No.: 19/091,048

(22) Filed: Mar. 26, 2025

(51) Int. Cl. G06T 15/08; G06T 17/00

(52) U.S. Cl. CPC G06T 15/08; G06T 17/005; G06T 2210/61

(57) ABSTRACT

When generating a representation of a scene that is to use a set of one or more voxels, one or more objects within the scene are identified from one or more views of the scene. A voxel data structure comprising a set of one or more voxels representing the scene is generated, and for objects identified within the scene, an object data structure representing the object is associated with one or more voxels of the voxel data structure representing the scene.

### BACKGROUND

The technology described herein relates to data processing, and in particular to representation of scenes using voxels in data processing systems.

Voxels may be used when representing a three-dimensional (3D) scene which contains one or more elements, e.g. objects, of interest. Each voxel (volume element) represents a volume in space (typically a cube), and may have associated properties (e.g. colour, transparency, or other properties), for example corresponding to the element(s) occupying that volume.

For example, when creating a digital reconstruction of a ‘real world’ scene, elements of that scene may be ‘voxelized’ (converted into a voxel-based representation).

The voxel-based representation may then be used to render and display those elements (for example as part of an extended reality (XR) application or medical visualisation) or otherwise used for analysing the scene (e.g. to identify hazards when performing autonomous driving).

Voxel-based representations may be advantageous for representing complex geometries and/or internal structures (which may be more challenging to capture with surface-based methods such as meshes). Furthermore, voxel-based representations may be intuitive to understand, and may be relatively straightforward to implement, for example in applications such as medical visualisation or extended reality where volumetric data may already be produced, and may allow applications to simply create and manipulate 3D environments dynamically.

The Applicants believe that there remains scope for improvements to efficiently generate voxel-based representations of scenes.

### BRIEF DESCRIPTION OF THE DRAWINGS

A number of embodiments of the technology described herein will now be described by way of example only and with reference to the accompanying drawings, in which:

FIG. 1 shows a data processing system;

FIG. 2 shows a graphics processor comprising a traversal unit in embodiments of the technology described herein;

FIG. 3 shows an alternative arrangement for a graphics processor comprising a traversal unit in embodiments of the technology described herein;

FIG. 4 show in more detail a traversal unit in embodiments of the technology described herein;

FIGS. 5A and 5B show example scenes represented by one or more voxels which may be represented by a voxel data structure and processed in the manner of the technology described herein;

FIG. 6 shows an example scene including objects which may be represented using voxel data structures in the manner of the technology described herein;

FIG. 7 shows an example voxel data structure that can be used in embodiments of the technology described herein;

FIG. 8 shows a data structure for storing a voxel representation of a scene in an embodiment of the technology described herein;

FIG. 9 shows another data structure for storing a voxel representation of a scene in an embodiment of the technology described herein;

FIG. 10 is a flowchart showing the obtaining of object data for representation in object data structures in an embodiment of the technology described herein;

FIG. 11 shows the inclusion of objection data and pose in a voxel representation of a scene in an embodiment;

FIG. 12 is a flowchart illustrating the representation of an identified object in an object data structure in an embodiment;

FIG. 13 is a flowchart illustrating the representation of an identified object in an object data structure in an embodiment; and

FIG. 14 illustrates data flow when triggering and performing a traversal in an embodiment.

Like reference numerals are used for like elements in the Figures where appropriate.

### DETAILED DESCRIPTION

A first embodiment of the technology described herein comprises a method of generating a representation of a scene using a set of one or more voxels, the method comprising:
identifying, from one or more views of a scene to be represented using a set of one or more voxels, one or more objects within the scene;
generating a voxel data structure comprising a set of one or more voxels representing the scene; and
for an object identified within the scene:
   associating an object data structure representing the object with one or more voxels of the voxel data structure representing the scene.

A second embodiment of the technology described herein comprises a data processing system operable to generate a representation of a scene using a set of one or more voxels, the data processing system comprising:
an object identification circuit configured to identify, from one or more views of a scene to be represented using a set of one or more voxels, one or more objects within the scene; and
a voxel data structure generation circuit configured to generate a voxel data structure comprising a set of one or more voxels representing the scene;
wherein the voxel data structure generation circuit is configured to, for an object identified within the scene by the object identification circuit:
associate an object data structure representing the object identified within the scene with one or more voxels of the voxel data structure representing the scene.

In the technology described herein, when generating a voxel-based representation of a scene, one or more objects are identified within the scene. For an (and in embodiments each) object identified within the scene, a representation of the object is associated with one or more voxels in a voxel data structure representing the scene.

As will be discussed further below, by identifying objects in a scene and associating representations thereof with a voxel-based representation of the scene, the processing required when generating and/or using the voxel-based representation (for example when running an augmented or extended reality application) may be reduced.

For example, identifying objects within a scene, and associating representations of identified objects with one or more voxels, may allow for the same representation of an object to be used for more than one instance of an object within a scene, which may allow the size of the voxel representation, and the resources, e.g. power consumption and/or bandwidth, required to generate the representation, to be reduced.

Furthermore, by associating object data structures for identified objects with voxels in a voxel data structure, the technology described herein may provide a more flexible structure for storing objects, and more efficient and flexible generation of a voxel-based representation of a scene. For example, the technology described herein may allow for representations of (e.g. different) objects to be stored at different resolutions.

The technology described herein also may allow for simpler interactions with objects within the representation of the scene, for example when running an augmented or extended reality application. For example, associating object data structures with a voxel representation of the scene may allow objects within the scene to be more easily identified when using the voxel representation for subsequent processing (for example to highlight objects within the scene or to calculate collisions with objects in the scene).

As noted above, the technology described herein is concerned with representation of scenes using a set of one or more voxels in data processing systems.

The scene which is to be represented by the set of one or more voxels may be any suitable and desired three-dimensional (3D) scene. The scene may contain one or more objects (elements of interest) which are respectively represented by one or more voxels. In other words, a (each) voxel may represent (at least part of) an object (element) within the scene. The scene may (also) contain other (non-object) features (elements) of interest, for example boundaries such as walls, which may also be represented by one or more voxels.

The scene to be represented could, for example, correspond to (represent) an environment which could be outdoors, indoors, or any other physical environment (for example an environment relating to a human body as may be of interest for medical imaging and diagnostics, or an environment within a mechanical system (such as a machine) as may be of interest for mechanical imaging and diagnostics, or a geographical environment, or other environment or object to be analysed).

The scene may be static or could change dynamically. For example, the scene may change dynamically as a viewpoint from which the scene is viewed changes, and/or as one or more elements of the scene change (for example, change shape, move, appear, disappear).

An object within the scene (which may be represented by one or more voxels) may comprise any suitable and desired object within a scene. An object within the scene may be static or moving.

Example objects (which may be represented by one or more voxels), in the case of an indoor or outdoor scene, include tables, chairs, plants, animals, people, automobiles, or other objects. Example objects (which may be represented by one or more voxels) in the case of a mechanical system may be mechanical components. Example objects (which may be represented by one or more voxels) in the case of a medical (biological) scene, may be biological structures imaged by a medical imaging system (for example ultrasound, scanning, computer tomography, endoscopy, or other medical imaging systems) such as for example bone, tissue, and organs, or other biological structures.

One or more (or all) of the voxels representing the scene may represent element(s) which are entirely virtual and not related to the ‘real world’ (corresponding to a virtual model, e.g. for a computer game, virtual reality application, or other application).

Additionally or alternatively, one or more (or all) of the voxels representing the scene may represent element(s) based on (corresponding to) the ‘real world’ (as may be the case in augmented reality, mixed reality, or other applications using ‘real world’ inputs for example as may be used for autonomous driving or robotic navigation).

It would be possible to represent the scene only using voxels, and in embodiments this is done. However, it would equally be possible to use a hybrid representation (and in embodiments this is done), for example the hybrid representation comprising a voxel-based representation in combination with one or more other types of representation, and in embodiments this is done.

In the technology described herein, the voxel representation of a scene is generated from (using) one or more views of the scene.

The one or more views of the scene may be any suitable views for representing the scene.

For example, and in an embodiment, the one or more views may comprise one or more two-dimensional views of the scene, for example with a (and in embodiments each) view showing a two-dimensional representation of the scene as seen from a viewpoint.

However, the views do not necessarily have to be two-dimensional. As such, in an embodiment the one or more views of the scene comprise one or more three-dimensional representations of the scene.

One or more of the views may be different views of (for example the same area of) the scene, for example captured at different times or from different viewpoints.

Alternatively, or additionally, the one or more views may comprise views of different spatial areas of the scene (for example where the scene to be represented is larger than can be captured in one go by a sensor).

In an embodiment, multiple of the views are combined (e.g. integrated), and the combined views of the scene used when generating the voxel representation. The combined views may be richer and less noisy, and therefore allow for improved object identification.

For example, a single view based on a single sensor (e.g. camera) reading may provide a relatively noisy representation of a scene (and any objects therein). By combining the view with further views, based on further sensor readings (in embodiments from different locations), noise may be reduced, allowing for the accuracy of the representation of the scene to be improved.

In embodiments, the one or more views may comprise one or more ‘real world’ views, showing the ‘real world’ as viewed from a particular viewpoint.

However, it will be appreciated that this need not be the case, and in another embodiment one or more views may comprise one or more features that are partially or entirely virtual. For example, one or more views may be generated by a processor, for example a graphics processor, or may comprise elements generated by a processor.

In some embodiments, one or more of the views are ‘hybrid’ views, comprising both elements from the ‘real world’ along with virtual elements.

In embodiments, identifying, from one or more views of a scene to be represented using a set of one or more voxels, one or more objects within the scene comprises obtaining the one or more views of the scene.

The one or more views of the scene may be obtained in any suitable and desired way.

For example, where the scene comprises one or more elements based on (constructed from) the ‘real world’, data relating to the ‘real world’ may be (may have been) obtained by a sensor (in embodiments of the data processing system), for example comprising any of: a visual light detector (camera), infra-red detector, x-ray detector, microwave detector, audio detector (microphone), depth sensor, sonar, radar, LiDAR or other suitable and desired detector. For example, LiDAR may be used to generate a point cloud for the scene.

Thus, in some embodiments, the generation of a voxel representation of the scene may be performed in ‘real-time’ as the one or more views are obtained by a sensor.

However, it will be appreciated that this need not be the case, and the one or more views may be views that have been captured previously, which may be obtained from storage, as desired. Thus, in an embodiment, obtaining one or more views of the scene comprises obtaining one or more views of the scene from storage (e.g. memory).

Alternatively or additionally, where the scene comprises one or more virtual elements, the view of the scene may comprise elements generated by a processor (e.g. a graphics processor).

Thus, in some embodiments, obtaining one or more views of the scene comprises generating one or more views of the scene using a processor (e.g. a graphics processor).

It will be appreciated that the one or more views of the scene may comprise any or all of views obtained from a sensor, from a processor and/or from storage, as desired.

In the technology described herein a representation of a scene comprising a set of one or more voxels is generated.

Generating a representation of a scene comprising a set of one or more voxels may (and does in embodiments) comprise determining and storing voxel data for a set of one or more voxels.

The voxel data may be any suitable and desired information that may be required for performing processing (e.g. rendering, or other processing) of the voxel(s).

A (each) voxel of the set of voxels should, and in an embodiment does, correspond to a (three-dimensional) volume (for example, and in embodiments, a cube) in the scene (in the three-dimensional space of the scene), with a (each) voxel (in an embodiment) corresponding to a single sampled volume (data point). Thus, the voxel data may, and does in an embodiment, comprise voxel coordinates (for example, x, y, z coordinates for one or more (or each) corner of a voxel).

A (each) voxel may have one or more properties associated with it, which are indicative of (visual and/or non-visual) properties of the volume represented by the voxel. Thus, the voxel data may comprise one or more properties associated with a voxel.

For example, one or more properties associated with a (each) voxel (and so the voxel data for a (each) voxel) may comprise any of: colour (for example, in red, green, blue (RGB) format), transparency (alpha), texture (indicating for example any of a material, reflectivity, plenoptic function), motion vector(s) (indicating for example a direction and speed of movement of the voxel), or other (non-visual) properties such as mass, density, strength or other (non-visual) properties.

A (each) voxel may have any suitable and desired size (represent any suitable and desired volume of the scene). For example, a (each) voxel could correspond to a same (smallest) sampling volume for the scene. However, it would equally be possible for voxels to vary in size, so as to vary the effective (volume) resolution at which (a region of, or an element (object) in) the scene is represented. For example, voxel size may vary depending on position in the scene, for example with voxel(s) which are closer to a user's viewpoint being smaller (corresponding to a smaller volume) than voxel(s) which are further away from a user's viewpoint. Voxel size may (additionally or alternatively) vary depending on the complexity of the region of the scene (the complexity of an element (object) in the scene) represented by the voxel(s), and/or depending on storage allocated (a memory footprint) to be used for representing the region of (an element (object) in) the scene. Thus, the voxel data for a (each) voxel may comprise a voxel size.

The voxel data could also contain an indication of whether the voxel is axis-aligned or not (for example a rotation about one, two, or three axes).

In the technology described herein, a voxel data structure is generated comprising a set of one or more voxels representing a scene. Generally, a voxel data structure may (and does) allow voxel data that is to be processed for respective voxels to be determined.

In an embodiment, the voxel data structure spatially sorts the voxel data. Thus, the voxel data structure may be (and is in embodiments) used to identify one or more voxels that occupy a particular volume of a scene, and thus allow voxel data to be processed for the volume to be determined.

Accordingly, and in embodiments, the voxel data structure may comprise a plurality of nodes representing respective volumes of the scene. The plurality of nodes may represent any suitable and desired volumes within the scene as appropriate. The volume associated with a (each) node may be any suitable and desired shape, in embodiments a cuboid (e.g. a cube).

In embodiments, the plurality of nodes comprises at least a set of one or more end (leaf) nodes that contain (are associated with) data relating to one or more voxels that occupy the volume associated with the respective end (leaf) node.

In some embodiments, voxel data for one or more voxels is stored in a (any) end (leaf) node of the set of one or more end (leaf) nodes that represents a volume comprising the one or more voxels (such that the voxel data may be read directly from the voxel data structure).

Alternatively or additionally, a (any) node of the set of one or more nodes may indicate a location of data to be processed when processing one or more voxels. For example, the node may include one or more pointers indicating locations in storage of voxel data.

In an embodiment, the nodes of the set of one or more end (leaf) nodes relate to non-overlapping volumes.

In some embodiments, the scene is divided into respective (in an embodiment equally sized, in an embodiment equally shaped) volumes, with a (each) node of a set of one or more end (leaf) nodes representing a respective one of the volumes.

Alternatively, in other embodiments, the volume that a (and in an embodiment each) end (leaf) node corresponds to may be determined based on the volume of the one or more voxels that the node contains data relating to. In some embodiments, the volume of a (each) end node may correspond exactly to the volume of one or more voxels. In other embodiments, the volume of a (each) node may not be exact, and for example may comprise a bounding box drawn from one or more voxels that the node is associated with.

For example, and in an embodiment, a node of the set of nodes may represent an element (e.g. object) in the scene, which may be represented by one or more voxels. The volume that the node represents may comprise the exact volume of the one or more voxels representing the element, or may be a bounding box of the one or more voxels representing the element.

It will be appreciated that the volumes represented by the set of end (leaf) nodes may be arranged in any other suitable way, as desired.

In embodiments, one or more (or all) end (leaf) nodes have an associated volume which contains respective one or more voxels in their entirety (so that an end (leaf) node forms a bounding box for one or more voxels). This may occur, for example for end (leaf) nodes which are axis-aligned and which contain one or more axis-aligned voxels (so that the (leaf) node, and its respective voxel(s) each correspond to a volume, e.g. cuboid, e.g. cube, with its axes oriented along x, y, and z axes that correspond to the axes of the three-dimensional scene to be processed, which may be the world axes).

In embodiments, the volume associated with a (and in embodiments each) end (leaf) node is axis-aligned, and sized to fit one or more axis-aligned voxels in their entirety.

However, the Applicant has recognised that it may desirable to permit one or more voxels not to be axis-aligned (for example, corresponding to a volume, e.g. cuboid, e.g. cube, with its axes rotated relative to the x, y and z axes (world axes) of the three-dimensional scene to be processed). This may better describe elements in a scene which are not axis-aligned (for example are rotated). Thus, in embodiments, a (any) end (leaf) node may comprise data relating to one or more voxels which are not axis-aligned. A non-axis-aligned voxel could fit entirely within a single end (leaf) node (for example a sufficiently large axis-aligned end (leaf) node, or a non-axis-aligned end (leaf) node), or a non-axis-aligned voxel could span multiple end (leaf) nodes.

In embodiments, the voxel data structure is a hierarchical data structure.

In such embodiments, the plurality of nodes may comprise one or more further sets of one or more (non-leaf) nodes representing volumes within a scene, with a (each) (non-leaf) node of the further set(s) of (non-leaf) nodes indicating one or more (other) nodes that are contained within the volume of the scene that the (non-leaf) node represents.

Thus, in embodiments, the voxel data structure comprises a plurality of nodes representing respective volumes of the scene, the plurality of nodes comprising one or more end (leaf) nodes that contain (indicate) data to be processed for a respective volume of the scene, and one or more (non-leaf) nodes that indicate one or more other nodes to be processed for a respective volume of the scene.

In this regard, the Applicant has recognised that, since voxels represent volumes in space, data relevant to voxels can be efficiently accessed using a hierarchical data structure which spatially sorts the voxel data. In this regard, the hierarchical data structure may also be referred to herein as an “acceleration data structure”.

Example hierarchical data structures which may be used to spatially sort voxels include a BVH tree (bounding volume hierarchy tree), a KD-tree, an Oct-tree, a grid hierarchy, a BSP tree (binary space partitioning tree).

In an embodiment, the hierarchical data structure is configured as a tree structure, with nodes arranged hierarchically according to node volume size.

In embodiments each (non-leaf) node is a parent node for a respective set of child nodes, with the parent node volume encompassing the volumes of its respective child nodes in their entirety. Thus, in embodiments, each (non-leaf) node is associated with a respective plurality of child node volumes each representing a (in an embodiment non-overlapping) sub-volume within the overall volume represented by the node in question.

Each (non-leaf) node could be associated with any desired number of child nodes, for example such as two, three, four, five, six, seven, eight or more child nodes. Each (non-leaf) node may have the same number of child nodes, or the number of child nodes could be permitted to differ among the (non-leaf) nodes. In embodiments each parent (non-leaf) node has a different set of child nodes, in embodiments so that no child node is shared between multiple parent (non-leaf) nodes.

The hierarchical data structure (tree structure) may originate at a (single) (root) node having a largest node volume, and branch through nodes having smaller volumes until a leaf node is reached. A leaf node is thus an end of a branch. A (each) leaf node does not have any child nodes.

Various other arrangements would be possible and the technology described herein may in general be used with any suitable hierarchical data structure.

The (e.g. hierarchical) voxel data structure (for example having any of the features described above) may be generated (built) in any suitable and desired way based on the scene to be processed as represented by one or more voxels.

In an embodiment, as described above, one or more end (leaf) nodes of the voxel data structure contain (are associated with) data relating to one or more voxels that occupy the volume associated with the respective end (leaf) node.

Thus, in embodiments, when a voxel (one or more voxels) representing a scene falls within a volume represented by an end (leaf) node of the voxel data structure, that leaf node is provided with (is configured to contain) data relating to that voxel (those voxels).

In the technology described herein, one or more voxels in the voxel data structure are associated with an object data structure representing an object.

Thus, as will be discussed further below, the voxel data structure may (and does in an embodiment) have (support/allow) end (leaf) nodes that comprise or indicate (e.g. point to a location in storage of) an object data structure.

It would be possible to have (permit) (only) a single type of end (leaf) node, comprising (only) a single type of information, and in embodiments this is done.

However, the Applicant has recognised that it may be advantageous to permit (support) plural types of end (leaf) node, each comprising a different type of information relating to one or more voxels representing a scene.

Thus, in embodiments, the voxel data structure is able to include/configured to allow plural (different) types of end (leaf) node (comprising different types of information).

For example, and in embodiments, types of information which an end (leaf) node may comprise include any of: voxel data or a pointer to a region of storage storing voxel data (the voxel data describing properties of voxel(s)); hash data (indicating that a hash function is to be used to access voxel data from storage); an indication of one or more additional data structures are to be traversed to obtain voxel data; and an indication that a (shader) program is to be executed.

The type of end (leaf) node (type of information stored in an end (leaf) node) may be apparent (derivable) from the data (information) (relating to one or more voxels representing a scene) stored within the end (leaf) node. Alternatively, the type of end (leaf) node (type of information stored in an end (leaf) node) may be indicated in any suitable and desired way. For example, an (each) end (leaf) node may be associated with (for example store, for example in a suitable data field or as metadata) an indication of its type.

In embodiments, an (any) end (leaf) node is permitted to change type (the type of information stored in an end (leaf) node is permitted to change, for example between any of the types disclosed herein).

In embodiments (e.g. instead of an end (leaf) node directly comprising or indicating a location in storage of voxel data), a (any) end (leaf) node may indicate a further data structure is to be used (walked)(traversed) to identify (determine) voxel properties.

The further data structure may be referred to herein as a “bottom level acceleration structure” (BLAS)).

The further data structure (BLAS) may comprise a hierarchical data structure (for example having any of the features discussed herein with respect to hierarchical data structures), for example a tree. The further data structure (BLAS) may provide (e.g. spatially sort) information relating to voxel(s) (e.g. of an element (instance)) in model space. (In comparison, the acceleration data structure ending in the end (leaf) node in question can be considered a “top level acceleration structure” (TLAS), which may spatially sort the world space of the scene to be processed.)

In embodiments, when an end (leaf) node indicates that a further data structure (BLAS) is to be used, there may be multiple further data structures (BLAS) available to be used.

In the case that multiple further data structures (BLAS) are available, the end (leaf) node could itself indicate which further data structure (BLAS) is to be used. Alternatively, the data processing system (for example a traversal unit) could select a further data structure (BLAS) to use.

In the case that a further data structure (BLAS) is a hierarchical data structure, one or more end (leaf) nodes of the further data structure may contain (or point to storage containing) voxel data (the voxel data describing properties of the voxel(s), for example any of the voxel properties described herein). In this case, data relating to the voxel(s) may be obtained by (the traversal unit) walking (traversing) the (appropriate) further (hierarchical) data structure (BLAS), until a leaf node of the further (hierarchical) data structure is reached.

In the technology described herein, for an object identified within a scene, an object data structure representing the object is associated with one or more voxels of the voxel data structure representing the scene.

In general, and as will be discussed further below, a (and any) object data structure may describe (include representations for) one or more objects that the object data structure represents.

Thus, the voxel structure may be (and is in an embodiment) used to describe (and represent) the positions of objects within a scene, and the object data structure(s) may be (and are in an embodiment) used to describe (define) the properties of those objects.

A (and each) object data structure may (and does in an embodiment) comprise a representation (“model”) of one or more objects, which may be used when performing processing for volumes of a scene that include the object.

In an embodiment, a representation of an object in an object data structure comprises object data, which may be used when performing processing for the object. The object data may be any suitable and desired data for the processing of an object.

In some embodiments, the object data for an object may be in the form of one or more (object) voxels, and therefore may comprise voxel data (as described above) to be used when processing an object.

However, the object data need not comprise voxels (or comprise only voxels). For example, and in an embodiment, the object data for an object may comprise a three-dimensional mesh that can be (and is) used for processing for the object.

An object data structure may, of course, contain any other suitable representation of an object, as desired.

Objects within a scene may be identified in any suitable and desired way.

In an embodiment, image segmentation (for example semantic segmentation) is performed on the one or more views of the scene, and volumes of the scene that contain objects are identified.

It would be possible to (only) identify that regions of a scene are objects (i.e. identify a region as containing an object) or not objects (identify that the region does not contain an object), and in an embodiment that is what is done.

However, in embodiments, identifying objects comprises performing object classification, such that objects are identified as such, and a classification is assigned to the object (for example indicating a type of object).

In embodiments, identification (and in embodiments classification) of objects may be performed using a machine learning process, for example performed by a neural engine (neural network processing unit, NPU). Other techniques for identifying and classifying objects may, of course, be performed as desired.

Different instances of an object may be identified in any suitable and desired way. For example, when a (new) object is identified, the object may be compared with previously identified objects and a level of similarity determined. If the level of similarity of the new object with a previously identified object is sufficient, e.g. greater than a threshold value, then the (new) object may be determined to be a further instance of the previous object.

Alternatively, or additionally, where object classification may be performed, and instances of the same or similar objects may be identified on the basis of the object classification.

As will be discussed further below, identifying (different) instances of (e.g. similar or identical) objects within a scene may allow for the size of the representation to be reduced, thereby allowing energy consumption and bandwidth for the device to be reduced.

Other arrangements are, of course, possible.

The Applicants have recognised that an object within a scene may have a particular pose (orientation). It would be possible to represent the object in an object data structure (e.g. only) in the pose it is present in the scene, and in an embodiment that is what is done.

However, in other embodiments, the representation of the object in an object data structure may not have the same orientation as present in the scene.

In such embodiments, identifying an object within a scene in an embodiment comprises identifying a pose (orientation) of the object, and associating the object data structure with one or more voxels in an embodiment comprises including an indication of the pose of the object in the voxel data structure for the one or more voxels.

For example, and in an embodiment, where the voxel data structure comprises one or more end (leaf) nodes (for example as part of a hierarchical data structure as described above), an indication of the pose of an object may be included in an end (leaf) node for the one or more voxels.

By determining a pose of an object, and providing an indication of the pose in the voxel data structure, “standard” representations of objects may be used (associated with one or more voxels) for an identified object, independent of the orientation of the object in the scene.

For example, where multiple instances of an object are present in a scene, having different poses, a single representation of the object, along with the pose of the respective instances, may be used when processing voxels including an instance of the object.

The pose of an object in the scene may be determined in any suitable or desired way. For example, and in embodiments, a pose determining algorithm, such as PoseCNN may be used.

In other embodiments, the pose of an object may be defined based on a property of an object, for example with respect to a longest dimension of an object.

Other arrangements are, of course, possible as desired.

In some embodiments, an “initial” pose of an object may be determined based on a first set of one or more views of a scene. Further sets of one or more views of the scene may (subsequently) be used (if necessary) to update the initially determined pose, as desired.

In the technology described herein, for an object identified within a scene, an object data structure representing the object is associated with one or more voxels of a voxel data structure representing the scene. An object data structure for an identified object may be associated with one or more voxels in any suitable and desired way.

In some embodiments, associating an object data structure with one or more voxels of a voxel data structure comprises including an object data structure representing an object in the voxel data structure with respect to one or more voxels.

For example, in embodiments where the voxel data structure comprises a set of one or more leaf nodes (for example in a hierarchical data structure), as described above, the object data structure may be (and is in embodiments) included in a (and any) end (leaf) node of the voxel data structure that includes one or more voxels to be associated with the object data structure.

However, in other embodiments, a (and each) object data structure may be stored separately to the voxel data structure. Thus, the object data structure may be a further (separate) data structure to the voxel data structure.

In such embodiments, associating an object data structure with one or more voxels may comprise including an indicator in the voxel data structure with respect to one or more voxels, the indicator indicating a location (e.g. in storage) of the object data structure.

For example, in embodiments where the voxel data structure comprises a set of one or more end (leaf) nodes (for example in a hierarchical data structure), as described above, a (and any) end (leaf) node comprising one or more voxels to be associated with an object data structure may comprise an indicator (e.g. a pointer) indicating the location in storage of the object data structure.

In such embodiments, the voxel data structure can be considered a top-level acceleration structure (TLAS), which may spatially sort voxels in scene (e.g. world) space and a (and each) object data structure can be considered a bottom-level acceleration data structure (BLAS), which provides information for representing one or more objects (for example, and as will be discussed further below, one or more instances of a same object, or one or more different (e.g. related) objects), and wherein one or more end (leaf) nodes of the top level acceleration data structure indicate (e.g. comprise a pointer to) one or more bottom-level acceleration data structures to be traversed to identify data to be processed with respect to the volume that the end (leaf) node represents.

In embodiments, the object data for an object may (also) be arranged in a hierarchical data structure (i.e. the object data structure may be a (volumetric) hierarchical object data structure), including a plurality of nodes which can be traversed to determine (object)(voxel) data to be processed for respective volumes of the object.

In such embodiments, a (each) node of the object data structure in an embodiment relates to a volume in object space (i.e. in a co-ordinate system defined with respect to that object). In an embodiment, the object data structure may be traversed until an end (leaf) node of the object data structure is reached containing (indicating) voxel data to be processed for a volume that the end (leaf) node of the object data structure represents.

Accordingly, in an embodiment, a (any) object data structure comprises a plurality of (object) nodes representing respective volumes of an object, the plurality of nodes comprising one or more end nodes that indicate data to be processed for a respective volume of the object. In an embodiment, the plurality of nodes comprise one or more (further) (object) nodes that indicate one or more other (object) nodes to be processed for a respective volume of the object.

Thus, a (each) object data structure may act as a bottom level acceleration structure (BLAS), with the voxel data structure acting as a top level acceleration structure (TLAS) as described above. In embodiments, both the voxel data structure and a (and in an embodiment each) object data structure comprise (volumetric) hierarchical data structures, as described above.

It would be possible to associate a (separate) object data structure with the voxel data structure for each object that is identified, independent of the similarity between objects in the scene, and in an embodiment that is what is done.

However, in embodiments, when multiple instances of an object are present within a scene, (only) a single object data structure is stored, which is then used with respect to (each of) multiple instances of the object.

Accordingly, in an embodiment, identifying one or more objects within a scene comprises determining whether more than one instance of a (particular) object is present within a scene (to be represented respectively by different ones or more voxels). The instances of the object in an embodiment comprise objects that are similar (in some embodiments identical) to one another. For example, if the scene is a dining room comprising a table and multiple chairs, it may be determined that there are more than one instance of a “chair” object.

When plural instances of an object are identified within a scene, a (single) object data structure may be (and is in an embodiment) associated with multiple groups of one or more voxels (respectively corresponding to different volumes of the scene that contain the different instances of the object). In an embodiment, a (single) object data structure is associated with a respective group of one or more voxels (e.g. end (leaf) node of the voxel data structure) for each instance of the object in the scene. As described above, the (single) object data structure may be (and is in an embodiment) a (volumetric) hierarchical data structure.

In such embodiments, an indicator (e.g. pointer) indicating a location in storage of the (single) object data structure for the object may be included in the voxel data structure for each of the multiple respective one or more voxels.

For example, where the voxel data structure comprises a hierarchical structure as described above, indicators may be included in each end (leaf) node comprising one or more voxels corresponding to volumes that include an instance of the object.

As such, in embodiments, identifying one or more objects within a scene comprises determining whether more than one instance of an object is present within the scene and the method comprises, when it is determined that more than one instance of an object is present within a scene:
associating a (single)(common)(the same) object data structure for the object with more than one group of one or more voxels in the voxel data structure.

The processing circuits are in an embodiment correspondingly configured to operate in this manner.

In an embodiment, associating the (single) object data structure with more than one group of one or more voxels comprises including an indicator indicating a location in storage of the object data structure for each of more than one groups of one or more voxels in the voxel data structure.

In embodiments, where the voxel data structure is a hierarchical structure, an indicator indicating the location in storage of the object data structure is included in respective leaf nodes comprising the respective groups of one or more voxels.

In this regard, the Applicants have identified that scenes (for example man-made environments) will often include multiple similar or identical objects. For example, an office environment may comprise multiple chairs, desks, computer displays etc. By providing an association between multiple (e.g. each) of respective ones or more voxels (each representing a volume of the scene comprising an instance of an object) and a (e.g. single) object data structure for representing the object, the number of object data structures that are stored may be reduced.

In turn, this may allow for a representation of a larger scene to be maintained on a device, and therefore may reduce the need to stream a representation off a device or regenerate a representation. This may reduce the amount of compute and sensor resources required for using a voxel representation, and therefore may reduce the energy consumption and/or bandwidth of the device.

Furthermore, this may also allow (e.g. only) a single representation of an object to be obtained (for example generated from one or more views of a scene) and used with respect to multiple instances of the object within a scene. This may reduce the processing required when generating a representation of a scene (e.g. from one or more views of the scene).

The object data structure(s) of the technology described herein can be obtained in any suitable and desired way.

In some embodiments, an object data structure for representing an object is generated when an object is identified. For example, and in embodiments, object data for an identified object may be obtained (determined) from one or more views of a scene (for example, using sensor data) and used to generate an object data structure.

Alternatively or additionally, when an object is identified, a previously generated object data structure (or object data stored in such an object data structure) may be used with respect to the object (i.e. associated with one or more voxels).

For example, and in embodiments, an (existing) object data structure comprising object data corresponding to an identified object may be identified.

The existing data structure may, for example, be identified by comparing an object identified within one or more views of a scene with previously stored object data structures for the scene.

In some other embodiments an object data structure (or object data for use therein) may be identified from a database of potential objects comprising object data (or object data structures). The database of potential objects may be stored in storage of the data processing system. Alternatively, the database of potential objects may be stored remotely (for example in the cloud), and accessed by the data processing system when identifying objects.

In embodiments, when a region of a scene that contains an object is identified (e.g. by image segmentation as described above), a (and any) object(s) within the region are compared with a database. When it is determined that the object is contained in the database (the object is recognised from the database), an object data structure (or object data therefrom) from the database is used with respect to the object. The object data structure (or object data) for the object may be copied from the database to a memory of the data processing system, or an indication of the location of (e.g. pointer to) the data in the database may be used with respect to the object.

When it is determined that the object is not present in the database, an object data structure (or object data for use therein) may be generated from one or more views of the scene.

Accordingly, in embodiments, for an object identified within a scene, associating an object data structure representing the object with one or more voxels of a voxel data structure comprises:
determining whether an existing object data structure is available for an identified object; and
when an existing object data structure is available for an object, associating the existing object data structure with one or more voxels for the identified object.

Identifying and using an existing object data structure to represent a (newly identified) object may provide a more complete and robust representation of the object (e.g. than can be determined solely from one or more views of a scene).

For example, use of an existing object data structure to represent a (newly identified) object may allow for a “full” representation of the object to be included in a voxel representation of a scene, even where there may be some gaps in data obtained from one or more views of the scene (e.g. where an object is partially occluded, contains reflective materials, or is too close/far from a sensor obtaining the views).

It can be determined that an existing object data structure is available for an identified object in any suitable and desired way.

For example, data from one or more views of a scene (e.g. sensor data) may be compared with object data stored in existing object data structures, and a similarity determined.

In other embodiments, where a machine learning algorithm is used to identify and categorise objects, an identified object may be matched to existing object data structures by e.g. classifications provided by the machine learning algorithm.

As discussed above, objects within a scene may be present in different orientations (poses). in an embodiment, when an object is identified, a pose of the object is also identified. In an embodiment, representations of objects in a (each) object data structure are stored having a standard pose. The standard pose may be defined in any suitable and desired way, for example by using a pose determining algorithm or from a property of the object, as described above.

When an object is compared with object data structures (for example that have been previously stored and/or from a database), in an embodiment the comparison is made using the standard pose. In this way, instances of the same object may be identified as such more efficiently, and even if the objects have different poses. For example, a standard pose may simplify categorising and comparing a new object with an existing object.

In some embodiments, associating the existing object data with one or more voxels may comprise obtaining (e.g. downloading from a database of object data structures) a previously generated object data structure with respect to the object. In other embodiments, associating the existing object data with one or more voxels comprises obtaining (e.g. downloading from a database of such object data) previously generated object data to populate an object data structure.

In an embodiment, when object data is not available for an object, object data for the identified object is generated from one or more views of the scene, and a (new) object data structure may be generated (or an existing object data structure further populated) for the object accordingly.

In some embodiments, a (and each) object data structure may (only) comprise a single representation of an object (which may be in embodiments be used for multiple instances of an object, as described above).

However, in some embodiments, an object data structure(s) may (be operable to) comprise plural representations of objects.

For example, and in embodiments, an object data structure may comprise representations for (and so comprise or indicate object data to be processed with respect to) more than one different object.

In an embodiment, object data may be stored in a hierarchical manner, comprising a plurality of nodes that may be traversed to allow object data to be used with respect to one or more objects to be determined, with leaf nodes of the object data structure representing a (specific) object.

For example, in embodiments where object classification is performed, a class and optionally a sub-class may be determined for the object. In such an embodiment, an object data structure may comprise a set of nodes of an object data structure representing one or more classes of object, each node of which may comprise one or more further nodes representing sub-classes within each class. There may be further levels (sets of nodes) within each sub-class to distinguish different objects as desired.

As a specific example, in a scene comprising multiple different chairs, each of these chairs may be classified in the class of “chair”, and then the different chairs assigned to different subclasses (e.g. “arm chairs”, “dining chairs” etc.). Object data for each different chair in a sub-class (e.g. chair of a particular type) may be stored in further nodes within each sub-class.

As will be described below, different sub-classes of items within a class of items may be similar to one another, and storing hierarchical object data structures in this manner may allow for e.g. at least some object data for different objects to be shared, such that the (total) amount of data required to store the object data structure may be reduced.

Alternatively, or additionally, a (any) object data structure may comprise different representations of a (same) object. For example, an object data structure may comprise plural representations of an object that represent the object at different resolutions.

Other arrangements are, of course, possible.

Such hierarchical object data structures may simplify the storage of object data. Furthermore, as will be discussed below, storing object data in a hierarchical manner may allow for the data required to store similar objects to be reduced.

In such embodiments, where a (any) object data structure is a hierarchical structure which may be traversed to obtain object data, associating an object data structure with one or more voxels in the voxel data structure may comprise associating object traversal data with one or more voxels in the voxel data structure, in embodiments by including or indicating object traversal data in a (leaf) node comprising the one or more voxels. The object traversal data allows the object data structure to be traversed to obtain a representation of (object data for) a (particular) object for the one or more voxels. The object traversal data may be any suitable and desired object traversal data that allows an object data structure to be traversed to obtain a representation of (object data for) a (particular) object.

For example, where as discussed above, the object data structure comprises one or more classes, and one or more sub-classes thereof, the object traversal data may comprise an indication of the class and sub-class of the object.

As discussed above, in embodiments the object data structure comprises a plurality of nodes representing different volumes in object space, and arranged hierarchically with end (leaf) nodes of the object data structure comprising (indicating) object (e.g. voxel) data for a volume that the end (leaf) node represents. In such embodiments, it would be possible to store separate sets of end (leaf) node for different related objects (such as objects in different subclasses). However, the Applicants have identified that at least some volumes of such similar objects are likely to be the same, such that at least some of the end (leaf) nodes may be shared between different objects.

Thus, in embodiments, the object traversal data may be usable when traversing a hierarchical object data structure to determine one or more nodes of the object data structure to traverse. For example, the data processing system may be operable to use the object traversal data to determine whether a (particular) node (volume) is to be processed for a (particular) object.

Additionally or alternatively, the data processing system may be operable to traverse a (any) object data structure based on other information. For example, where the object data structure comprises multiple representations of a (same) object at different resolutions, the data processing system may obtain traverse the object data structure to obtain object data based on a desired resolution for processing.

The Applicants have appreciated that in many scenes, there may be objects that are similar, but not necessarily identical. For example, a scene may comprise multiple objects having the same shape, but different colours. In other examples, an object may have some portions that are identical to another object, and other portions that are different. For example, an object may have been damaged. For example, a “chair” object may be identical to other “chair” objects within a scene, but with one arm damaged or missing. Many other differences are, of course, possible.

In embodiments, where a (so called “derivative”) object is determined to be similar, but not identical, to an existing object, (in an embodiment only) a difference between the derivative object and the existing object may be stored in an object data structure.

Thus, a (any) object data structure may comprise a “general” model (representation) for an object, along with one or more differences, which can be combined to obtain a representation of (object data for) a particular (different, e.g. similar) object within a scene.

Similarly, where the object data structure is a hierarchical data structure, comprising a plurality of nodes including end (leaf) nodes containing (indicating) object (e.g. voxel) data to be processed for respective volumes that the end (leaf) node represents, one or more “shared” nodes may be used to represent both an existing object and a new “derivative” object(s), and one or more other nodes of the object data structure may be used for only one of the new “derivative” object and/or the existing object.

For example, where the “derivative” object includes an additional feature compared to an existing object, one or more additional nodes may be included in the object data structure with respect to the “derivative” object, and where the “derivative” object includes fewer features one or more nodes of the existing object data structure may be marked as (only) for use with respect to the existing object, and not the new “derivative” object.

Which node is to be processed for which object may be identified in any suitable and desired way, such as the inclusion of an appropriate flag with respect to a node.

When an object data structure is associated with a voxel data, object traversal data is in an embodiment included in (e.g. an end node of) the voxel data structure, the object traversal data being usable to determine which object that the data structure represents is associated with the voxel data structure (e.g. which nodes of the object data structure should be used).

By (e.g. only) storing differences between a new object and an existing object (rather than for example storing a full new set of object data), the amount of object data that is stored for the scene may be reduced. This in turn may allow for more data for a scene to be stored locally to a data processing system, thereby reducing power consumption for the device.

Accordingly, in an embodiment, an (any) object data structure comprises a plurality of nodes which are traversable to determine object data to be processed for a plurality of objects, wherein the plurality of nodes include a first set of one or more nodes representing a first object and a second set of one or more nodes representing a second object, wherein one or more nodes are shared between the first set of nodes and the second set of nodes.

In another embodiment a (any) object data structure comprises one or more nodes comprising a representation of an object, and one or more further nodes storing a difference from a representation of an object.

In each of these embodiments, associating an object data structure with one or more voxels of a voxel data structure in an embodiment comprises including object traversal data in the voxel data structure.

Such “derivative” objects may be identified in any suitable and desired way. For example, and in an embodiment, a newly identified object may be compared against existing objects as described above.

In an embodiment, when an object is identified, a similarity of the object to one or more existing objects is determined. The similarity of a (newly identified) object to one or more existing objects can be determined in any suitable and desired way. For example, and in embodiments, a hash data structure may be used, or by comparing sensor data to data obtained by probing an (existing) object model with one or more rays.

In some embodiments, similarity is determined hierarchically (at different resolutions). For example, similarity between an identified object and an existing object may be determined first using a coarser grid (for example, and in embodiments, to identify a suitable “general” model (e.g. a suitable existing object data structure) for the object), and then using a finer grid (for example, and in embodiments, to compare the object with different existing objects within an object data structure). In some embodiments, similarity at different resolutions is determined whilst integrating (combining) views of the scene.

In other embodiments, derivative objects may be identified using an appropriate classification algorithm (e.g. a machine learning algorithm).

Accordingly, in an embodiment, determining whether an existing object data structure is available for an identified object comprises:
comparing the identified object with one or more representations of objects in an existing object data structure; and
when an object is identified to be identical to a representation of an object in an object data structure, associating the object data structure with one or more voxels comprises including an indication of the representation of the object in the voxel data structure; and
when an object is identified to be (sufficiently) similar, but not identical, to a representation of an object in an object data structure:
   storing a difference between the representation and the identified object in the object data structure, wherein associating the object structure with one or more voxels comprises including, in the voxel data structure, object traversal data which is usable to obtain the difference from the object data structure.

In some embodiments, similarity may be determined spatially across the object (i.e. the similarity of different portions of an object with an existing (representation of an) object may be determined).

When it is determined that there is a relatively high similarity for a portion of a (newly identified) object with a portion of an existing object, and a relatively low similarity with another part of an existing object, it may be determined that the (newly identified) object is a variant of the existing object.

In such embodiments, in an embodiment (only) the portion of the (newly identified) having relatively low similarity is added to the appropriate object data structure (as a variant of the existing object).

In this way, representations for similar portions of objects may only be generated once, and then these similar portions may be used with respect to other similar objects. This may reduce the power and energy consumption of the data processing system. Furthermore, the memory footprint required for storage of the representation of the scene may be reduced.

It would be possible to include each (newly identified) object in the scene in object data structures in the same way, and in an embodiment that is what is done.

However, in embodiments, one or more characteristics of an identified object are determined and used when including the object in an object data structure. In an embodiment, a machine learning classifier is used to determine one or more characteristics of the object. For example, and in embodiments, the one or more characteristics of the object may be whether the object is (likely to be) unique, organic, rigid, static, or any other suitable property. The amount of resources used for generating models of the object may be (and are in an embodiment) varied on the basis of the one or more characteristics.

For example, the one or more characteristics may be used to determine whether or not to search an existing object database. In this regard, the Applicants have identified that certain characteristics of objects can be used to determine whether an object is likely to be similar to an existing object.

For example, organic objects such as plants are more likely to be unique, such that searching for the organic object is unlikely to return a match. Similarly, non-rigid and dynamic objects are less likely to be matched to an existing object. In contrast, non-organic, rigid and static objects are more likely to return a match.

Thus, the Applicants have identified that, by using a characteristic of the object to determine whether or not to search an existing database of objects, time and resource can be saved by not searching the database for objects that are unlikely to return a match.

Accordingly, in an embodiment, identifying one or more objects within a scene comprises:
classifying a (each) identified object to identify one or more properties of the object; and
using the one or more properties of the identified object to determine whether an existing object data structure is likely to be available; and
when it is determined that an existing object data structure is not likely to be available for the identified object based on the one or more properties:
   generating an object data structure for the identified object without determining whether an existing object data structure is available for the object.

Furthermore, the one or more characteristics may be used to determine the amount of processing resource used to generate and store a model of an object. For example, for newly identified object that is not already present in a database, or is not included in an existing object data structure, the one or more characteristics may be used to determine a resolution that the model of the object is stored at. Objects that are more likely to occur multiple times, and/or are unlikely to change, such as objects that are static, rigid and/or non-dynamic, may be stored at higher resolutions than objects that are likely to be unique. Other arrangements are also possible.

Similarly, when a newly identified object is present in a database, or is present in an existing object data structure, then the one or more characteristics may be used to determine whether to improve the existing model (representation) of the object (for example to further integrate the model (e.g. to use additional views of the scene to improve the model), to create a more accurate model, and/or to optimise (e.g. balance) the existing model).

Accordingly, in an embodiment, identifying one or more objects within a scene comprises:
classifying an (each) identified object to identify one or more properties of the object;
using the one or more properties of an identified object to determine whether (data for) the identified object is likely to be re-usable and/or re-used (e.g. for the scene and/or for another scene); and
when it is determined that (data for) an identified object is likely to be re-usable and/or re-used based on the one or more properties of the identified object, using the one or more views of the scene to improve a representation of the object in an existing data structure.

In an alternative or additional embodiment, identifying one or more objects within a scene comprises:
classifying a (each) identified object to identify one or more properties of the object;
using the one or more properties of an identified object to determine whether (data for) the identified object is likely to be re-usable and/or re-used (e.g. for the scene and/or for another scene);
when it is determined that (data for) an identified object is likely to be re-usable and/or re-used based on the one or more properties of the identified object, storing a higher resolution representation of the object in an object data structure; and
when it is determined that an identified object is not likely to be re-usable and/or re-used based on the one or more properties of the identified object, storing a lower resolution representation of the identified object in an object data structure.

The processing circuits are in an embodiment correspondingly configured to operate in this manner.

Alternatively or additionally to using a characteristic of an object to determine whether to improve an existing model (representation) of an object, the number of instances of the object in the scene may be used to determine whether to improve the model. For example, (the model used for) objects that are identified to be present in a scene multiple times may be stored at a higher resolution than objects that are only present once.

Where machine learning algorithms are used to classify objects, when multiple instances of an object are determined to be present within a scene (and in an embodiment when the object has one or more particular, in an embodiment selected characteristics, such as being rigid and static), the object may be used to train the classification algorithm, and the re-trained network used in the future.

In this way, the Applicants have appreciated that generating and/or improving a representation of an object, for example by obtaining (e.g. using a sensor) and analysing (further) views of the scene may be computationally expensive. The Applicants have thus identified that processing resources can be focussed on objects that are (or are likely to be) present (and/or used) multiple times. As such, the models used for such objects (which are likely to be referenced multiple times) may be optimised, with relatively less time spent on objects that are only present once, or that are likely to change.

A voxel representation of a scene in accordance with the technology described herein may be (and in embodiments is) used when performing processing for the scene. The voxel representation may be used for any suitable and desired processing relating to the scene.

For example, and in embodiments, it may be desired to perform graphics processing (graphics processing operations) relating to the scene. The graphics processing may comprise, for example, rendering the scene to generate an image (frame), for example for display (on a display, for example a screen, of the data processing system). The graphics processing could additionally or alternatively comprise render-to-texture processing based on the scene. The graphics processing to be performed could be for any suitable and desired application, for example a video game, or extended reality (e.g. augmented reality, or virtual reality) application.

Alternatively or additionally, it may be desired to perform processing relating to the scene other than graphics processing (for example which does not consist of (or does not require any) graphics processing). Such processing may comprise (and in embodiments comprises) analysis of the scene, for example to analyse the positions and/or properties of element(s) represented by voxel(s) in the scene. This may be for the purpose of navigation (for example by an autonomous vehicle or other robotic device, for example using SLAM (simultaneous localisation and mapping)) or for medical, mechanical, geographical, computational fluid dynamic analysis, or other scene analysis.

In embodiments, processing for the scene may be performed in real-time, with the processing being continually performed (updated) (for example as a view-point and direction from which the scene is viewed changes, and/or as the scene itself changes).

In the technology described herein, generating a voxel representation of a scene comprises generating a voxel data structure comprising a set of one or more voxels representing the scene.

When using the voxel representation to perform processing for a scene, the voxel data structure may be (and is) used to identify (voxel data) for one or more voxels to be processed.

In the technology described herein, for one or more objects identified within a scene, an object data structure is associated with one or more voxels of a voxel data structure representing the scene.

Accordingly, when using a voxel representation of the scene for processing, object data may be (and is in embodiments) obtained from an object data structure for one or more voxels.

In an embodiment, using a voxel representation of a scene for processing comprises using a voxel data structure comprising a set of one or more voxels representing the scene to identify one or more voxels to be processed, and when one or more voxels that are identified to be processed are associated with an object data structure representing an object, using the associated object data structure when processing the one or more voxels.

Using the associated object data structure when processing the one or more voxels may, and does in an embodiment, comprise using the object data structure to obtain object data to process for the one or more voxels. As noted above, the object data may itself be or comprise one or more (object) voxels, which may be processed for the one or more voxels of the voxel data structure representing the scene.

The object data may be obtained from an object data structure in any suitable and desired way. For example, where an object data structure is stored in (an end (leaf) node of) the voxel data structure, object data may be fetched directly from the voxel data structure. Where an indication of a location in storage (e.g. a pointer) of the object data structure is included in a voxel data structure, the indication (e.g. pointer) may be used to fetch the object data structure (or object data stored in the object data structure).

In an embodiment, as described above, an object data structure stores (is capable of storing) more than one representation of an object (and so stores multiple sets of object data). In such embodiments, using the object data structure to fetch object data in an embodiment comprises determining which representation of an object is to be processed for one or more voxels, and obtaining object data for the representation that is to be processed for the one or more voxels.

As described above, in some embodiments, object traversal data is provided in the voxel data structure (e.g. in a leaf node thereof) with respect to one or more voxels. In such embodiments, the object traversal data may be, and is in an embodiment, used to determine which representation of an object is required for the one or more voxels (to traverse the object data structure), and to fetch object data from the object data structure accordingly.

In other embodiments, an object data structure may be traversed on the basis of a property of the processing to be performed. For example, where the object data structure comprises multiple representations of an object having a different resolution, the object data structure may be traversed on the basis of the desired resolution of processing.

As set out above, in some embodiments one or more representations in an object data structure may be stored as a difference between the object and another (e.g. general) object. In such embodiments, obtaining object data may comprise fetching the general object data, and traversing the object data structure to obtain difference data thereto. These may be, and are in an embodiment, combined to obtain the object data for the object.

The technology described herein extends to such use of object data structures when performing processing of a voxel representation.

A further embodiment of the technology described herein comprises a method of processing a representation of a scene that uses a set of one or more voxels, wherein the representation of the scene comprises a voxel data structure comprising a set of one or more voxels representing the scene, and in which one or more voxels of the voxel data structure are associated with an object data structure representing an object within the scene, the method comprising:
traversing the voxel data structure to identify a voxel to be processed; and
when the identified voxel to be processed is associated with an object data structure representing an object within the scene:
using the association to determine an object data structure to be used when performing processing for the voxel; and
using the determined object data structure when performing processing for the voxel.

Another embodiment of the technology described herein comprises a data processing system operable to process a representation of a scene that uses a set of one or more voxels, wherein the representation of the scene comprises a voxel data structure comprising a set of one or more voxels representing the scene, and wherein one or more of the voxels of the voxel data structure are associated with an object data structure representing an object within the scene, the data processing system comprising:
a voxel data structure traversal circuit configured to traverse a voxel data structure to identify voxels to be processed;
an object data structure determining circuit configured to use an association between a voxel and an object data structure representing an object within a scene to determine an object data structure to be used when performing processing for the voxel; and
an object data structure processing circuit configured to use a determined object data structure when performing processing for a voxel associated with the object data structure.

As will be appreciated by those skilled in the art, these embodiments of the technology described herein may, and in an embodiment do, comprise any one or more or all of the optional features of the technology described herein, as appropriate.

Thus, for example, in embodiments, using the object data structure to perform processing for the one or more voxels comprises using object traversal data to identify a representation of an object in the object data structure, and using the representation of the object when performing processing for the one or more voxels.

As described above, the voxel data structure in an embodiment spatially sorts the scene, and therefore in an embodiment the voxel data structure may be (and is in embodiments) used to identify respective voxels to be processed for different regions of the scene.

The voxel data structure may be used in any suitable and desired way to access data relating to voxel(s), for example falling within a region of interest in the scene.

In embodiments, the voxel data structure is a hierarchical data structure as described above. The hierarchical data structure may be traversed (for example by an appropriate traversal unit of the data processing system) to arrive at one or more nodes containing (indicating) voxel data to be processed for a (particular) region of a scene.

In embodiments, the (hierarchical) voxel data structure may be traversed based on an origin (a position, for example in the scene, for example from which the scene is (or is to be) viewed, which may be defined as x, y, z coordinates) and/or a direction (direction vector) (for example corresponding to a direction in which the scene is (or is to be) viewed), to arrive at a leaf node representing a volume of interest in the scene (for which any voxel(s) therein are to be processed). The traversal could also be performed based on a range (distance) into the scene to be considered (for example, a distance from a viewer or camera).

In this regard, an origin and direction of ‘viewing’ the scene (a view direction), in the context of an extended reality application (e.g. AR application) requiring processing of the scene could be based on a position and orientation of a user (as determined, for example by head tracking). For other program applications, for example performing scene analysis (e.g. for autonomous driving), the origin and direction of ‘viewing’ the scene need not correspond to an actual human user of the scene, but rather a direction of ‘viewing’ for the purposes of the scene analysis.

It would be possible to determine the origin and direction (and optionally range) to be used for the traversal in any suitable and desired way.

In embodiments, traversing the hierarchical data structure comprises (the traversal unit is configured to traverse (walk) the hierarchical data structure by) starting at one or more nodes corresponding to a largest volume in the hierarchy (one or more “root” nodes), and based on the origin and/or direction (of viewing) to follow one or more branches (through any child node(s)) until an end (leaf) node is reached (or, where the walk is limited by a range into the scene, until that range is reached, if sooner).

This may comprise, for a (non-leaf) node associated with a set of plural child nodes, determining which child node(s) are of interest, comprising determining (testing) which child node volume(s) are intersected (based on the origin and/or direction for the traversal). The node(s) which are determined to be intersected may then have their child nodes tested for an intersection, and so on until an end (leaf) node is reached (the end (leaf) node having no child nodes) (or until the range into the scene is reached, if sooner).

The node volume(s) to be tested for volume intersection may be obtained in any suitable fashion. For instance, the node volumes may be stored in storage (for example of or accessible to the data processor, for example a main off-chip memory of the data processing system, for example accessible via a cache hierarchy), and loaded from storage as required for volume intersection testing of a given node.

The Applicant has recognised that the traversal (walk) of the hierarchical data structure, as described herein, may have similarities to the traversal of a ray tracing acceleration data structure performed for ray tracing in a graphics processor.

In this regard, the present traversal may be performed, in effect, by casting one or more ‘rays’ with an origin and direction through the hierarchical data structure, and following a path through the hierarchical data structure accordingly, until a leaf node is reached. This may comprise, testing the ‘ray’ for intersection with one or more (child node) volumes associated with a node of the hierarchical data structure to determine which of the associated volumes (child nodes) is intersected by the ray, then subsequently testing the ray for intersection with the volumes associated with the (child) node in the next level of the hierarchical data structure, and so on, down to the lowest level (end (leaf)) nodes.

Thus, in some embodiments, the data processing system may at least in part, use an (existing) ray tracing unit of a graphics processor to perform some or all of the traversal operation, e.g. substantially as described in U.S. patent application Ser. No. 18/611,359, the entire content of which is incorporated herein by reference.

However, it is noted that a conventional ray tracing unit of a graphics processor, whilst capable of traversing a ray tracing acceleration data structure, typically is not configured for handling leaf nodes containing voxel data as are present in the hierarchical data structure of technology described herein. Thus, whilst the traversal unit of the technology described herein may share at least some circuitry (circuits) with an existing ray tracing unit (for the purposes of performing a traversal (walk)), it should, and in an embodiment does, have additional functionality and interacts with the data processing system in a different manner, as described herein.

Alternatively, a traversal unit could be, and in embodiments is, provided separately to (and does not share circuits with) a (any) ray tracing unit.

As noted above, the hierarchical data structure is in an embodiment traversed, until an end (leaf) node is encountered. When an end (leaf) node is encountered that contains data relating to one or more voxels, the traversal unit then triggers processing relating to the one or more voxels.

As described above, in the technology described herein, an object data structure is associated with one or more voxels of the data structure. Thus, triggering processing relating to at least one or more voxels in embodiments comprises obtaining and processing object data as described above.

However, as noted above, in embodiments, the hierarchical data structure is permitted to contain plural different types of end (leaf) node. In such embodiments, appropriate processing may be performed based on the type of end (leaf) node encountered.

Thus, whilst some end (leaf) nodes may be associated with object data structures as described above, it will be appreciated that not all end (leaf) nodes may be associated with object data structures.

Thus, when an end (leaf) node is encountered, the ‘type’ of end (leaf) node may be (and is in an embodiment) determined. The type of a (and any) end (leaf) node may be determined in any suitable and desired way.

For example, and in an embodiment, the type of an end (leaf) node may be determined based on an (explicit) indication of leaf node type provided for the leaf node (e.g. in a ‘type’ field).

Alternatively or additionally, the ‘type’ of an end (leaf) node may be, and is in an embodiment, determined based on the end (leaf) node data (relating to one or more voxels represented by the end (leaf) node). For example, the data processing system (e.g. a traversal unit thereof) may recognise (infer) an end (leaf) node type based on the data provided in the end (leaf) node relating to one or more voxels, for example by recognising one or more (or any of) an indication of a further data structure to be traversed, hash data, and an indication of a (shader) program to be performed (and the traversal unit configured to trigger or perform appropriate processing based on the recognised end (leaf) node type).

In embodiments, when an end (leaf) node is of a type (is determined by the traversal unit to be of a type) comprising voxel data (or a pointer to a region of storage storing voxel data) describing properties of one or more voxels falling within the volume of the end (leaf) node, the data processing system (e.g. traversal unit) tests (performs processing relating to one or more voxels comprising testing) whether a (any) voxel falling within the volume of the end (leaf) node is of interest and should be processed.

In embodiments, determining whether a (any) voxel should be processed comprises determining whether the end (leaf) node (actually) contains any voxel data.

In this regard, it is possible for an end (leaf) node (of the type which is to contain voxel data) to contain no voxel data (be empty) if no voxel falls within the volume associated with the end (leaf) node.

In embodiments, in response to determining that an end (leaf) node (of the type which is to contain voxel data) contains no data (is empty), a data processor of the data processing is informed (e.g. the traversal unit is configured to inform a data processor) that no voxel is to be processed (that there was no voxel intersect) (for example, by a traversal unit sending a message to an execution unit of a data processor that triggered the traversal).

When an end (leaf) node does (is determined to) contain voxel data for one or more voxels, the traversal unit may (then) determine whether any of the voxel(s) are of interest (are intersected) and should be processed. As described above, in some embodiments objects are represented by (the object data for an object comprises) one or more voxels. In such embodiments, a (each) voxel of the object data may be processed in the same way.

This may comprise determining (testing) whether a voxel is (any of the voxels are) is intersected, e.g. based on the origin and direction of the traversal. In this regard, whilst a voxel may fall within a leaf node volume, it may not actually be intersected.

In embodiments, determining whether a voxel is intersected comprises comparing the volume occupied by (of) the voxel against a position of interest within the end (leaf) node volume (as determined based on the origin and direction used for the traversal). The volume occupied by the voxel may be determined based on one or more (or all) of coordinates of the voxel and/or based on the (volume) size of the voxel (as may be indicated in the voxel data). In embodiments, determining whether an intersect occurs also comprises accounting for whether or not the voxel is axis aligned.

In embodiments, voxel transparency (for example as indicated in the voxel data) may be taken into account when determining whether any voxel(s) are of interest (are intersected) and should be processed. For example, if a voxel which is intersected is (at least partially) transparent, then the data processing system (e.g. a traversal unit thereof) may determine whether any other voxel(s) (for example lying behind the transparent voxel) are intersected.

In embodiments, when it is determined that a voxel is of interest and should be processed (when it is determined a voxel is intersected), appropriate processing (e.g. rendering, or other analysis) of the voxel by the data processor is triggered. This may be done in any suitable and desired way, for example by informing a data processor of the voxel(s) which should be processed. This may comprise informing the data processor that a voxel intersect has occurred, and in an embodiment indicating which voxels have been intersected.

In embodiments, processing relating to a scene represented by one or more voxels is performed by executing (program) instruction(s) on an execution unit of a (at least one) data processor of a data processing system.

In embodiments, a data processor comprising the execution unit that executes instructions (to which instructions are provided) for performing processing operations relating to the scene is a graphics processor (is configured as a graphics processor) (graphics processing unit, GPU) capable of performing (configured to perform) graphics processing (graphics processing operations), for example to render the scene to generate an image (frame) for display. The graphics processor may optionally be capable of performing (and used to perform) processing for the scene other than graphics processing. This may be appropriate, for example, where processing desired to be performed for the scene comprises graphics processing, or other processing that may be efficiently performed on a graphics processor.

In this regard, the graphics processor may be configured with any of the usual processing elements, circuits, units and stages (e.g. graphics processing pipeline) that a graphics processor may contain and/or execute for generating images (frames), for example for display, for example using rendering.

Alternatively or additionally a (at least one) data processor which is not a graphics processor may be used, with its execution unit(s) used for executing instructions to perform processing relating to the scene. This may be appropriate, for example, where the processing desired to be performed for the scene comprises processing other than graphics processing, e.g. and which is more efficiently performed on a processor other than a graphics processor.

For example, the data processor may be, a central processing unit (CPU), or a neural network processor (neural network processing unit, NPU) adapted for performing neural network processing (e.g. such as machine learning, ML). However, it would equally be possible to use any suitable and desired processor, for example such as a vector processor, a video processor (video processing unit, VPU), a sound processor, an image signal processor (ISP), a digital signal processor (DSP), or an accelerator.

The data processor(s) may (each) have a single execution unit, or plural programmable execution units (one or more, or all, of which may be used for executing program instructions for performing processing relating to a scene represented by one or more voxels).

For example, a data processor may comprise one or more processing cores (also referred to herein as “shader cores” in the case of a graphics processor) each having a respective execution unit.

The (each) (programmable) execution unit, in embodiments, comprises appropriate circuits (processing circuits/logic) for performing operations required (that may be required) of the execution unit. Thus, the (each) execution unit, for example, and in embodiments, comprises a set of at least one functional unit (circuit) operable to perform data processing operations for an instruction being executed.

The functional units can be implemented as desired and in any suitable manner, in embodiments as suitable hardware elements such as processing circuits (logic).

The data processing system in accordance with the technology described herein (and operated in the manner of the technology described herein) can be any suitable and desired type of data processing system comprising a data processor operable to execute instructions.

The data processing system may be implemented, for example, as part of any suitable and desired electronic device, e.g., such as a desktop computer, a portable computing device (such as a laptop, mobile phone, tablet, wearable computing device, or other portable device), robotic device, automobile (e.g. car, or van, or other automobile) or a purpose-built computing device (for example, a computing device for use in medical or other scenarios). Thus, the technology described herein also extends to an electronic device that includes the data processing system of the technology described herein (and on which the data processing system operates in the manner of the technology described herein).

It would be possible to implement the data processing system as part of a computing system comprising plural electronic devices, e.g., such as a distributed computing system (such as a cloud computing system). However, in embodiments the data processing system (at least the data processor, and the traversal unit) is provided within a single electronic device (and not distributed across plural electronic devices).

In embodiments, the data processor and traversal unit are implemented as a system-on-chip (SoC) (for incorporation into an electronic device).

The data processing system of the technology described herein may comprise any suitable and desired components and elements that a data processing system can comprise (in addition to the data processor and traversal unit).

The data processing system in embodiments comprises a host processor (central processing unit (CPU)) operable to execute applications (for example an augmented reality, virtual reality, robotic navigation, or scene analysis application) which may require processing to be performed relating to a scene represented by one or more voxels. The host processor may comprise a compiler and/or driver configured in the manner disclosed herein for generating program instructions to facilitate execution of processing for the application (by a programmable execution unit of a data processor, such as a graphics processor, or other data processor).

The data processing system may also comprise a display, for displaying information relating to the processing of the scene by the data processor (for example for displaying rendered image frames, or displaying information concerning the analysis of the scene, e.g. analysis results). The display could be any suitable and desired type of display, such as a screen or other display. A display processing unit (DPU) may be provided for controlling the display.

Alternatively, one or more images rendered by the data processing system may be printed, or may be sent to a remote display.

The data processing system may also comprise one or more environment sensors (for example, a camera, microphone, UV sensor, IR sensor, depth sensor (e.g. LiDAR) or other sensor), for detecting information relating to a ‘real-world’ environment (scene) to be represented using one or more voxels (to be “voxelized”).

The data processing system will also comprise storage for storing the data described herein and/or storing software for performing the processes described herein. This storage may comprise a main (off-chip) memory (e.g. SDRAM), and local (on-chip) storage (for example one or more caches, for example forming a cache hierarchy). The data processor (which is to perform processing relating to the scene represented by one or more voxels) may comprise and/or be in communication with any suitable and desired storage of the data processing system, for example as described herein.

The data processing system of the technology described herein may be implemented as part of any suitable system, such as a suitably configured micro-processor based system. In some embodiments, the technology described herein is implemented in a computer and/or micro-processor based system.

The various functions of the technology described herein may be carried out in any desired and suitable manner. For example, the functions of the technology described herein may be implemented in hardware or software, as desired. Thus, for example, the various functional elements of the technology described herein may comprise a suitable processor or processors, controller or controllers, functional units, circuits, processing logic, microprocessor arrangements, etc., that are operable to perform the various functions, etc., such as appropriately dedicated hardware elements (processing circuits) and/or programmable hardware elements (processing circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing circuits may share processing circuits, etc., if desired.

It will also be appreciated by those skilled in the art that all of the described embodiments of the technology described herein may include, as appropriate, any one or more or all of the features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on data processor, a computer program element comprising computer software code portions for performing the methods herein described when the program element is run on data processor, and a computer program comprising code adapted to perform all the steps of a method or of the methods herein described when the program is run on a data processing system.

The technology described herein also extends to a computer software carrier comprising such software which when used to operate a data processing system causes in a processor, or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

A number of embodiments of the technology described herein will now be described.

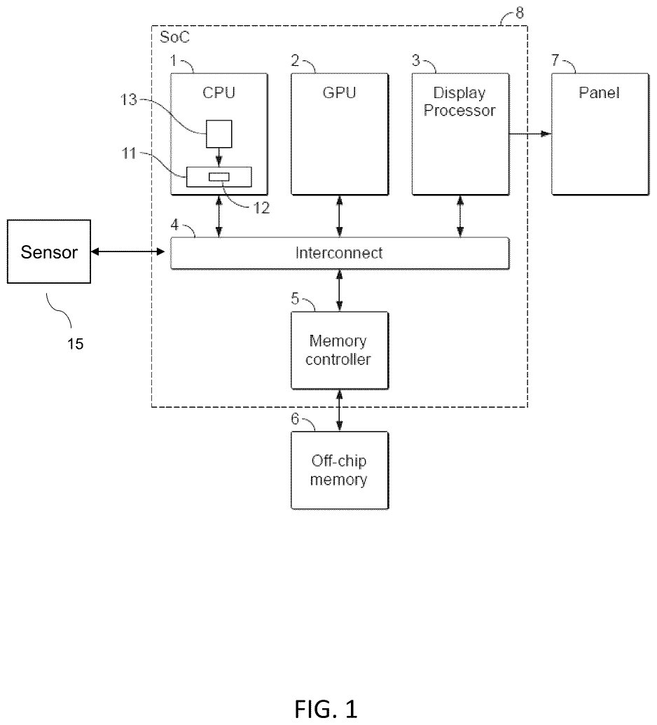

FIG. 1 shows an example data processing system in accordance with embodiments of the technology described herein.

The data processing system comprises data processors comprising a host processor in the form of a central processing unit (CPU) 1 and a graphics processor (GPU) 2 either or both of which may be used to perform processing for a scene represented by one or more voxels.

For example, the central processing unit 1 or graphics processor 2 could be used to perform scene analysis. The graphics processor 2 in particular may be used to perform rendering of a scene to produce frames (images) for display on a display 7 (the frames being provided to the display by a display processor 3). Other data processors not shown could also be provided, if desired, for example such as a neural engine, or other accelerators (which could also or instead be used to perform processing for a scene).

The system may be configured as a system-on-chip (SoC) 8, with the host processor 1, graphics processor 2 (and display processor 3) provided on a (same) chip, and operable to communicate via an interconnect 4. A memory controller 5 may also be provided to allow access to main, off-chip, memory 6 (for example, SDRAM).

In use of the data processing system, an application 13 (e.g. a game, augmented reality application, virtual reality application, or other application), executing on the host processor (CPU) 1 may require a scene to be processed (e.g. analysed, or rendered to provide a frame for display). The application 13 may provide commands in a high-level programming language, which are compiled (by a compiler 11 of the host processor) into program instructions for causing the desired processing to be performed.

When the processing is to be performed using the graphics processor 2 (e.g. comprises rendering), a driver 12 for the graphics processor 2 (which is executing on the host processor 1), may generate appropriate commands and data to be used by the graphics processor 2.

A sensor 15 (e.g. a camera) provides data regarding the “real-world” surroundings of the data processing system, which may be used by an application 13 running on the host processor 1 (for example when the application is an augmented or virtual reality application).

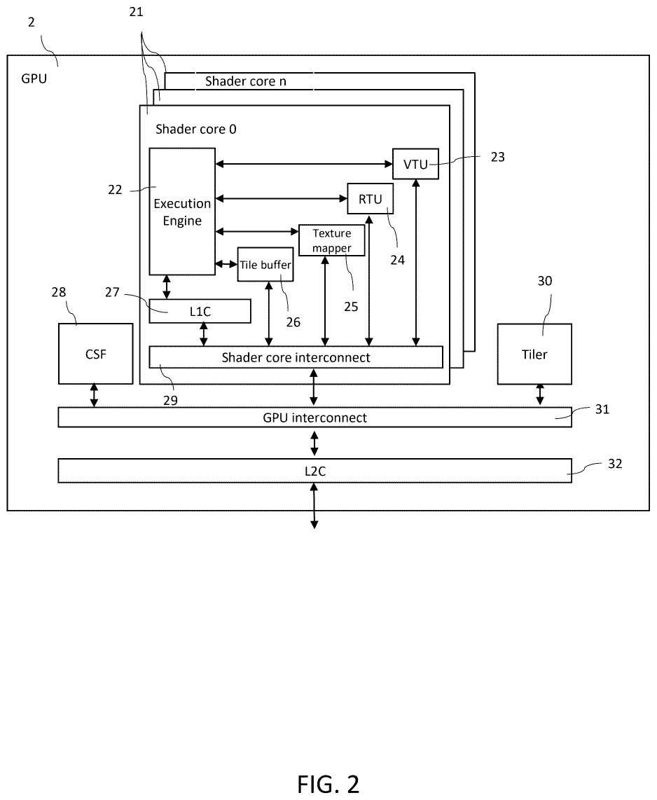

FIG. 2 illustrates an embodiment of the graphics processor (GPU) 2 of FIG. 1 in more detail, including a traversal unit 23 (voxel traversal unit “VTU”).

As shown in FIG. 2, the graphics processor 2 may comprise one or more processing cores 21 (shader core 0 to shader core n). The configuration of a single processing core 21 is shown, however each processing core 21 may have a similar configuration.

A (each) processing core 21 may comprise a programmable execution unit (circuit) (execution engine) 22 which is operable to execute instructions (for example, received for an application 13 executing on the host processor 1, via a driver 12), to perform data processing operations.

A (each) processing core 21 of the graphics processor 2 may comprise any suitable and desired components typically provided to facilitate performing graphics processing, for example a texture mapper 25, a tile buffer 26, and a ray tracing unit 24 (for performing ray tracing operations, such as traversing a ray tracing acceleration data structure and determining intersections of “rays” with primitives).

The components of (each) processing core 21 may have access to any suitable and desired storage, for example a cache hierarchy, for example comprising a level 1 cache 27 (integrated within the processing core 21), a level 2 cache 32 (external to the processing core), and the main off-chip memory of the data processing system.

Communication between components of a processing core 21, between processing cores 21, with other components of the graphics processor (not part of a shader core), and with storage, may be facilitated by one or more suitable interconnects, such as a shader core interconnect 29, and a GPU interconnect 31.

The graphics processor may also comprise (in addition to the processing cores 21) any suitable and desired other components for facilitating graphics processing, such as a command stream frontend (CSF) 28 (which may be operable to manage incoming work and distribute it among the processing cores 21), and a tiler 30 (when the graphics processor is operable to generate render outputs on a tiled basis).

In accordance with embodiments of the technology described herein, the graphics processor 2 is provided with a traversal unit (traversal circuit) 23 configured to traverse a hierarchical data structure to access data relating to a scene represented by one or more voxels.

The traversal unit 23 is in communication with the programmable execution unit 22, so that the execution unit can, in response to executing an instruction indicating that a traversal should be performed, cause a traversal by the traversal unit (by sending a message to the traversal unit to that effect).

In the embodiments shown, the traversal unit 23 is provided as part of the processing core 21 where the execution unit 22 resides, to allow direct communication between the execution unit and the traversal unit. However, the traversal unit could instead be provided externally to the processing core 21, or on another processing core 21.

In this regard, a single traversal unit 23 could be provided (for the graphics processor), and for example shared by plural shader cores (and triggered by plural different execution units). Alternatively, plural traversal units 23 could be provided, for example with one traversal unit 23 per processing core 21.

FIG. 2 shows the traversal unit 23 provided as distinct hardware unit, which does not share any circuit(s) with other components of the processing core, such as the ray tracing unit 24.

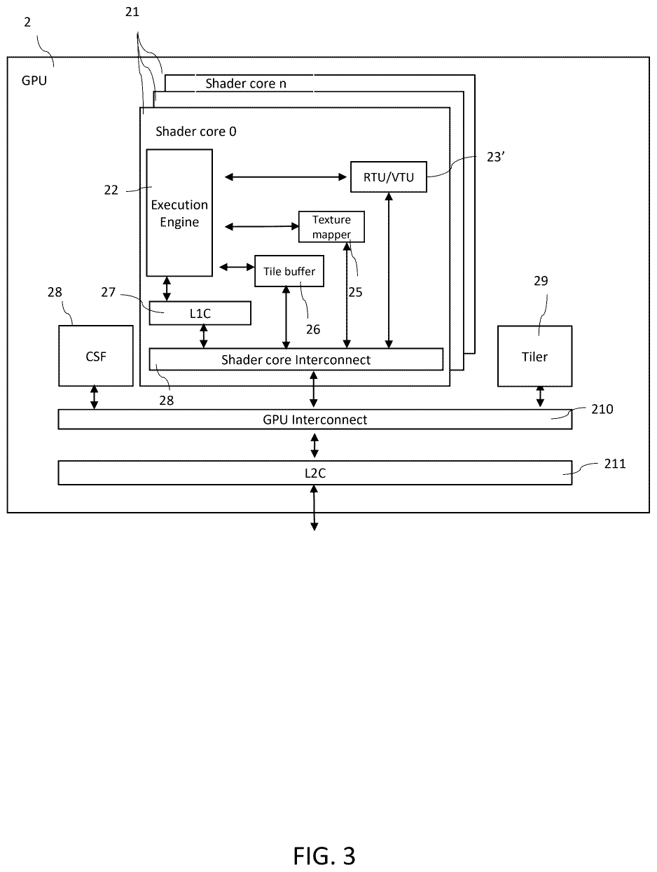

However, as discussed herein, and as illustrated in FIG. 3, it would be possible for the traversal unit to share (use) at least some circuit(s) of the ray tracing unit, so as to provide a combined ray tracing unit and traversal unit (voxel traversal unit VTU) 23′.

Whilst FIGS. 2 and 3 shows a traversal unit 23, 23′ provided for a graphics processor 2, it would equally be possible to provide traversal unit(s) for use by other data processors (such as a host processor, CPU, 1) in an analogous way. For example, in such embodiments, for a data processor (e.g. CPU) comprising a programmable execution unit operable to execute data processing operations, the execution unit may be in communication with a traversal unit 23 (for example, the traversal unit 23 and execution unit both provided within a same processing core), so that the execution unit in response to executing an instruction indicating that a traversal should be performed can trigger a traversal by the traversal unit 23.

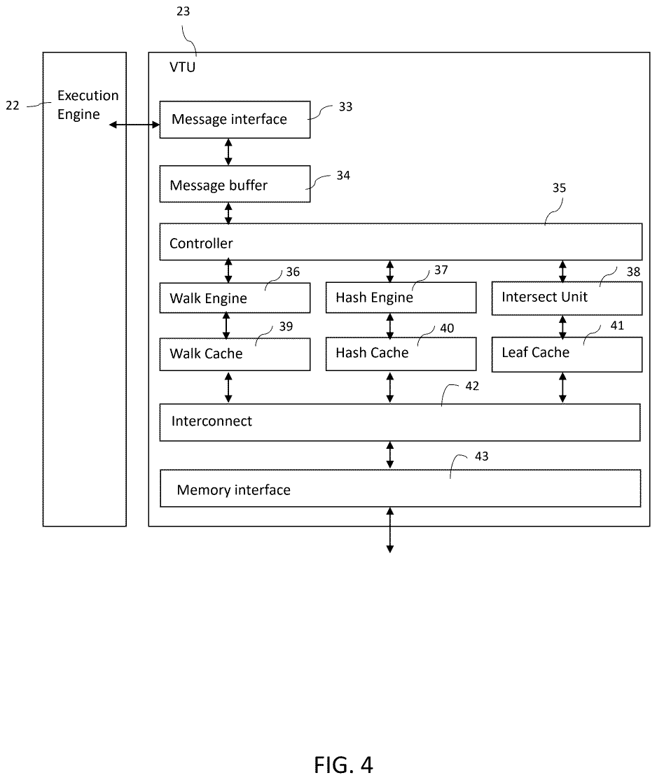

FIG. 4 shows in more detail a (voxel) traversal unit (VTU) 23 which may be used to traverse data structures stored in accordance with the technology described herein.

As illustrated in FIG. 4, the traversal unit 23 may comprise a message interface 33 for receiving messages from the execution unit 22, for example, the messages indicating that a traversal of a hierarchical data structure is to be performed (and for sending messages to the execution unit 22, for example communicating an outcome of, or an action to be performed in view of, a traversal which has been performed). The traversal unit 23 may also comprise a message buffer 34 for storing message data received from (or to be sent to) the execution unit 22.

The traversal unit 23 may also comprise a controller 35, for controlling the traversal unit 23 in response to incoming messages.

For example, the controller 35 may be operable to cause a walk unit (walk engine) 36 of the traversal unit 23 to walk (traverse) a hierarchical data structure.

In this regard, the traversal unit may comprise a (dedicated) walk unit 36 configured to walk (traverse) a hierarchical data structure until an end (leaf) node is reached. The walk unit 36 may be in communication with a storage such as walk cache 39 for storing data retrieved or generated during the traversal of the hierarchical data structure.

The walk performed by the walk unit 36 (and walk cache 39) may be similar to a walk of a ray tracing acceleration data structure performed for a ray tracing operation, and so it would be possible for the walk unit 36 (and walk cache 39) to share circuits with an existing ray tracing unit of the graphics processor. Alternatively, the walk unit 36 (and walk cache 39) could be provided specifically for (and only as part of) the traversal unit 23 (and not share circuits with any existing ray tracing unit of the graphics processor).

The traversal unit may also comprise one or more other units (circuits) to assist with handling end (leaf) nodes comprising data relating to one or more voxels (when they are encountered during a walk by the walk engine 36). These units (circuits) have functionality not found in a typical ray tracing unit and so are provided in addition to any existing ray tracing unit. These units may include an intersect unit 38 (with associated storage, leaf cache 41) configured to determine whether voxels for which data is provided in an end (leaf) node are actually of interest (are intersected), and a hash unit 37 (with associated storage, hash cache 40) for handling end (leaf) nodes indicating that a hash is to be used to access voxel data.

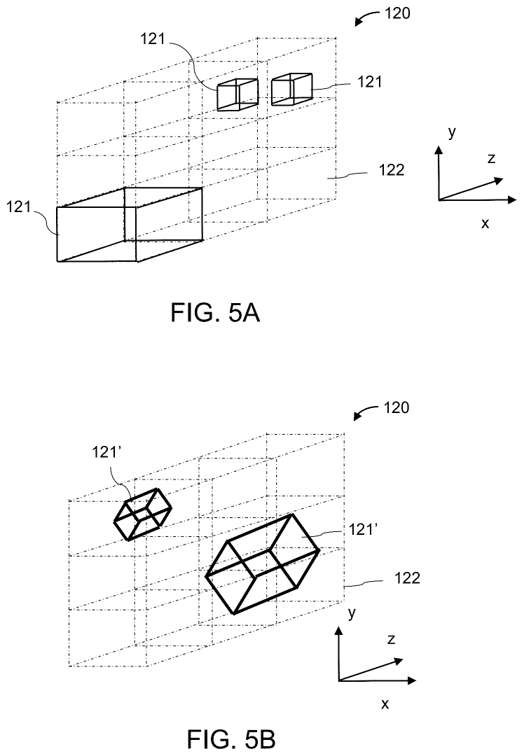

FIGS. 5A and 5B show example scenes 120 represented by one or more voxels 121, 121′, which may be represented by a voxel data structure and processed in the manner of the technology described herein.

The scene 120 may be any suitable and desired scene which is desired to be processed by a data processor, for example a virtual scene (e.g. to be displayed for a video game), or a scene which is based at least in part on a real-world scene (to be analysed or displayed, for example for an augmented reality application). The scene may have axes (corresponding to world axes), for example x, y and z axes as shown.

Elements (e.g. objects) in the scene may (each) be represented by one or more voxels 121, 121′.

A voxel, in this regard, is a three-dimensional volume, in an embodiment a cuboid-or cube-shaped volume. A voxel may have associated properties (such as colour, transparency, texture, movement vectors, size, coordinates, or other suitable and desired properties), as appropriate for the element (e.g. object) it represents.

One or more (or all) of the voxels 121 representing elements in the scene could be axis-aligned (so that their axis aligned with the x, y and z axes of the scene). However, it would also be possible for one or more of the voxels not to be axis-aligned, for example as shown for voxels 121′ in FIG. 5B. Non-axis-aligned voxels may be useful for representing elements (e.g. objects) in the scene which are not axis-aligned, e.g. are rotated (compared to the axes for the scene, as may be used when dividing the scene into volumes represented by nodes of the hierarchical data structure).

The voxels could all be the same size, or could differ in size (as illustrated). In this regard, the size of the voxels used for a particular region of the scene may depend on a resolution at which that region of the scene is represented (with larger voxels corresponding to a lower resolution, and smaller voxels corresponding to a higher resolution), and/or depend on the amount of storage assigned for (to be used for) storing that region of the scene (storing a greater number of smaller voxels uses more storage than a smaller number of larger voxels), and/or depend on the complexity of elements (objects) in that region of the scene.

For the purpose of storing voxel data for a scene, the scene can notionally be divided into a plurality of volumes 122 (for example as shown in FIGS. 5A and 5B). Data relating to any voxels 121, 121′ falling in a (respective) volume 122, can then be stored in a (respective) region of storage (e.g. in the main, off-chip, memory 5).

The volumes 122 could be configured (selected) (e.g. enforced) to include one or more voxels in their entirety (so as to form bounding volumes for the voxel(s) therein) (for example as shown in FIG. 5A). However, it would also be possible to permit voxels to span one or more volumes 122 (for example as shown in FIG. 5B).

The voxels of a scene may have different locations in space compared to one another (may fall within different volumes 122), and may have poor spatial locality (for example, if the elements they represent are not adjacent one another in the scene). In order to efficiently access voxel data from storage, a hierarchical data structure may be used.

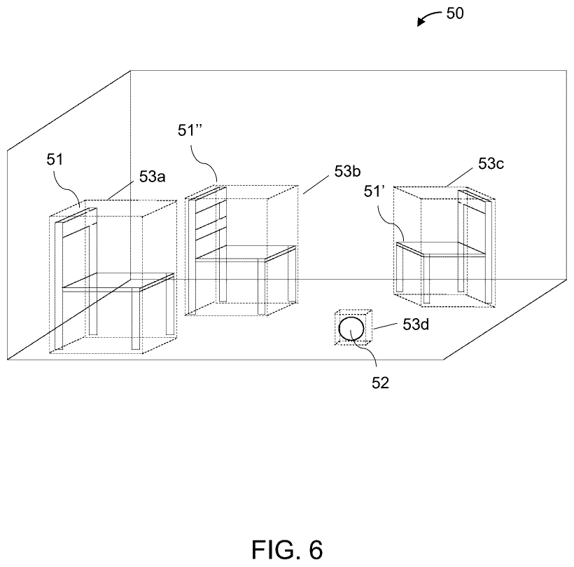

FIG. 6 shows an example scene including objects, which may be represented using voxel data structures in the manner of the technology described herein.

The scene of FIG. 6 includes four different objects, occupying volumes 53a, 53b, 53c, 53d of the scene. In particular, the scene includes three chairs (51, 51′, 51″) and a ball 52.

Chairs 51 and 51′ are identical, but chair 51′ has a different orientation (“pose”) within the scene.

Chair 51″ is similar to chair 51, but has an additional feature, and so can be considered a “derivative” of chair 51. Ball 52 is not similar to chair 51, and so can be considered as a different object.

In this regard, the example scene of FIG. 6 may be similar to many real-world scenes, for example in house-hold settings, where multiple similar or identical objects may be present.

Objects within a scene may be identified in any suitable and desired way. For example, it would be possible to identify volumes of the scene 50 that include objects using image segmentation.

It would be possible to simply identify the volumes 53 comprising objects, and in an embodiment that is what is done. However, in embodiments the objects in the scene are classified (such that chairs 51, 51′, 51″ are identified and classified as such, and ball 52 is identified and classified as a different “ball” object).

As noted above, chairs 51 and 51′ are identical, but have a different pose (orientation). The pose of an object may be identified in any suitable and desired way, such as using a pose-determining algorithm, for example PoseCNN.

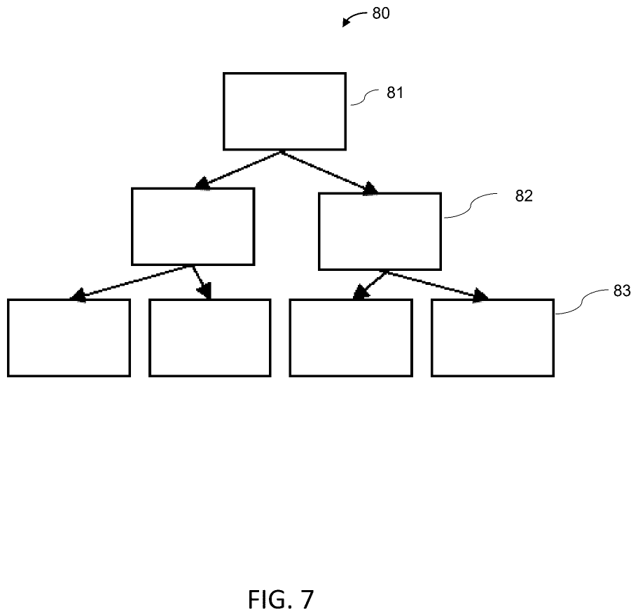

FIG. 7 shows an example voxel data structure 80 which can be used in embodiments of the technology described herein to represent a scene represented by one or more voxels, for example the scene of FIG. 6.

The voxel data structure 80 comprises a plurality of nodes 81, 82, 83, each associated with a volume of the scene. The nodes may be arranged in a tree structure (as shown in FIG. 7), with a single root node (volume) 81 which encompasses (branches to) plural child nodes (volumes) 82, which in turn encompass (branch to) plural child nodes (volumes) 83, and so on. The nodes representing at the end of a branch, and having no child nodes, are “leaf nodes” 83.

Whilst the example of FIG. 7 shows each parent node having two child nodes, it would be possible to have other numbers of child nodes if desired (such as three, four, five, or six).

Whilst the example of FIG. 7 shows the (hierarchical) voxel data structure having three hierarchical levels, more levels could be provided if desired, for example, with nodes 83 having child nodes, and so on until a leaf node is reached.

Each leaf node may represent a volume of the scene which is the same size, and which is axis aligned (for example, such as the volumes 122 shown in FIGS. 5A and 5B, or volumes 53 in FIG. 6). However, it would also be possible for leaf nodes to represent volumes which are different sizes and/or are not axis aligned.

In this embodiment, the leaf nodes of the hierarchical (voxel) data structure are used for storing data relating to one or more voxels of the scene which fall within the volume associated with the respective leaf node.

As such, by traversing the hierarchical data structure (from the root node) to a leaf node associated with a volume (region) of interest of the scene, data relating to voxel(s) falling within that volume can be accessed.

In the present embodiments, one or more objects are identified within a scene. One or more voxels within the scene are associated with an object data structure representing an object.

In the present embodiments, at least some of the leaf nodes of the voxel data structure are associated with an object data structure.

For example, in the scene of FIG. 6, objects 51, 51′, 51″ and 52 are identified as occupying volumes 53a, 53c, 53b and 53d respectively.

When using the (hierarchical) voxel data structure of FIG. 7 to represent the scene of FIG. 6, respective ones of the leaf nodes 83 of the (hierarchical) voxel data structure may represent volumes 53a, 53b, 53c and 53d. These leaf nodes are associated with an object data structure of the corresponding object occupying that volume, which may be used to identify appropriate object data for processing with respect to objects 51, 51′, 51″ and 52.

Thus, the voxel data structure 80 is traversable until a leaf node 83 is reached, indicating a volume containing an object (for example volumes 53a, 53b, 53c and 53d).

In some embodiments, the leaf nodes 83 of the voxel data structure may comprise the object data structure (i.e. object data may be comprised in the leaf nodes of the voxel data structure).

However, in embodiments the leaf nodes 83 indicate a (further) object data structure containing data for the objects.

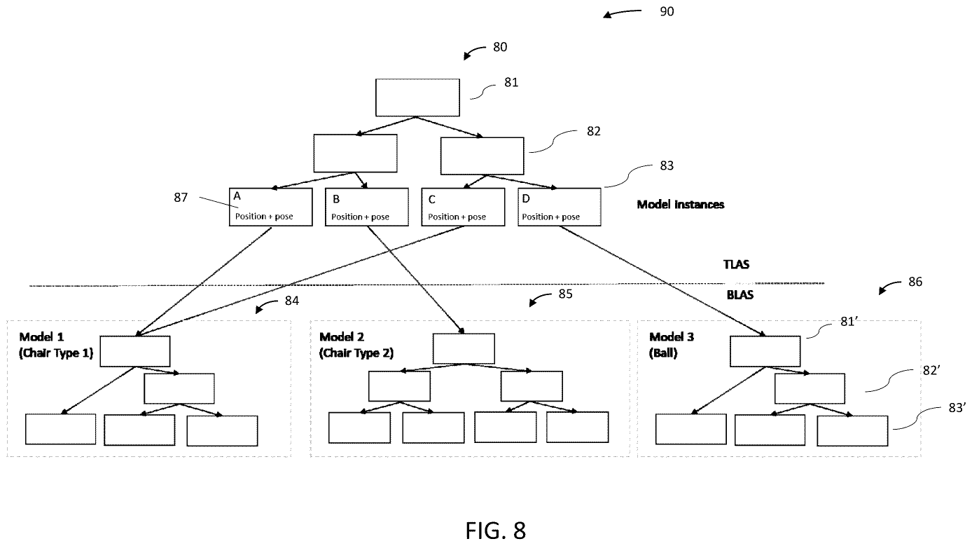

FIG. 8 illustrates a data structure for storing a voxel representation of the scene of FIG. 6 in an embodiment of the technology described herein.

The (overall) data structure 90 comprises a (hierarchical) voxel data structure 80, as described with respect to FIG. 7. At least some leaf nodes 83 of the voxel data structure represent volumes 53a, 53b, 53c and 53d respectively, containing objects 51, 51″, 51′, and 52.

Object data, for performing processing with respect to objects 51, 51′, 51″ and 52 is stored in a respective object data structure 84, 85, 86. It would be possible to store a (separate) object data structure for each object within the scene, regardless of whether those objects are identical, and in embodiments that is done.

However, in the present embodiments, the same object data structure 84 is used for both identical chairs 51, 51′ (located in volumes 53a, 53c). Accordingly, one object data structure 84 is associated associated with two leaf nodes of the voxel data structure 80, corresponding to volumes 53a, 53c comprising the different instances of the chair objects.

In this way, the data structure may be made smaller than if, for example, all of the object data is stored for each object individually. This may reduce the resources required to generate the representation. For example, by allowing more of the scene to be stored locally on a device generating and using the representation, the amount of data that is either accessed from storage remote to the device generating and using the representation, or that is re-generated from views of the scene, may be reduced.

Further object data structures 85 and 86 are used for the different chair object 51″ and the ball 52.

The object data structures 84, 85, 86 store object information, which may be used when processing objects 51, 51′, 51″ and 52.

In the present embodiments, the object data structures 84, 85, 86 are also hierarchical data structures, comprising a plurality of nodes 81′, 82′, 83′. The object data structures in this embodiment are tree structures, which are traversable to obtain object data, for example from leaf nodes 83′.

In this embodiment, the leaf nodes 83′ of the object data structures 84, 85, 86 may comprise voxel data (or a pointer to a storage location storing voxel data). However, it will be appreciated that an object data structure does not necessarily need to contain voxel data, and may contain any suitable and desired data that may be processed with respect to an object.

Voxel data that may be stored in a leaf node (or in a storage location pointed to by a leaf node), may comprise a colour of the voxel (for example in red, green, blue (RGB) format), and transparency (alpha). The voxel data could also comprise any other suitable and desired properties for the voxel, such as voxel coordinates (if the volume of the voxel differs from that associated with the leaf node), motion vector(s) for the voxel, or any other suitable and desired data.

In the present embodiments, the object data structures comprise a hierarchy of volumes in a similar way to the voxel data structure, except that the volumes for the object data structure are defined in object space (rather than with respect to the scene (e.g. world space)). Thus, the object data structures 84, 85, 86 comprise a plurality of nodes 81′, 82′, 83′, each associated with a volume of a respective object. The nodes may be arranged in a tree structure (as shown in FIG. 8), with a single root node (volume) 81′ which encompasses (branches to) plural child nodes (volumes) 82′, which in turn encompass (branch to) plural child nodes (volumes) 83′, and so on. The nodes representing at the end of a branch, and having no child nodes, are “leaf nodes” 83′.

Different objects within a scene may have different poses to that stored in a corresponding object data structure (i.e. the co-ordinate system used to define the object data structure may not be aligned with the orientation of the object within a scene). Furthermore, in some scenes more than one instance of an object are present in a scene in different orientations, for example chairs 51, 51′ in FIG. 6.

Accordingly, leaf nodes 83 of the voxel data structure 83 that are associated with an object data structure include information 87. The information indicates a pose of the object (indicating which orientation that the representation of the object in the object data should be placed in the scene). The information 87 also includes position information, which indicates where the object in question should be positioned in the volume that the leaf node 83 represents.

As a whole, the representation 90 of FIG. 8 may be traversed to determine data to be processed for a region (volume) of the scene. To identify what data (if any) is required for a particular location (volume) of a scene, the voxel data structure may be traversed until a leaf node 83 of the voxel data structure 80 is reached (and thus the voxel data structure forms a top-level acceleration data structure (TLAS)), and then a further hierarchical object data structure 84, 85, 86 (forming a bottom level acceleration data structure (BLAS)) is required to be traversed (in order to arrive at a leaf nodes 83′ comprising object (e.g. voxel) data).

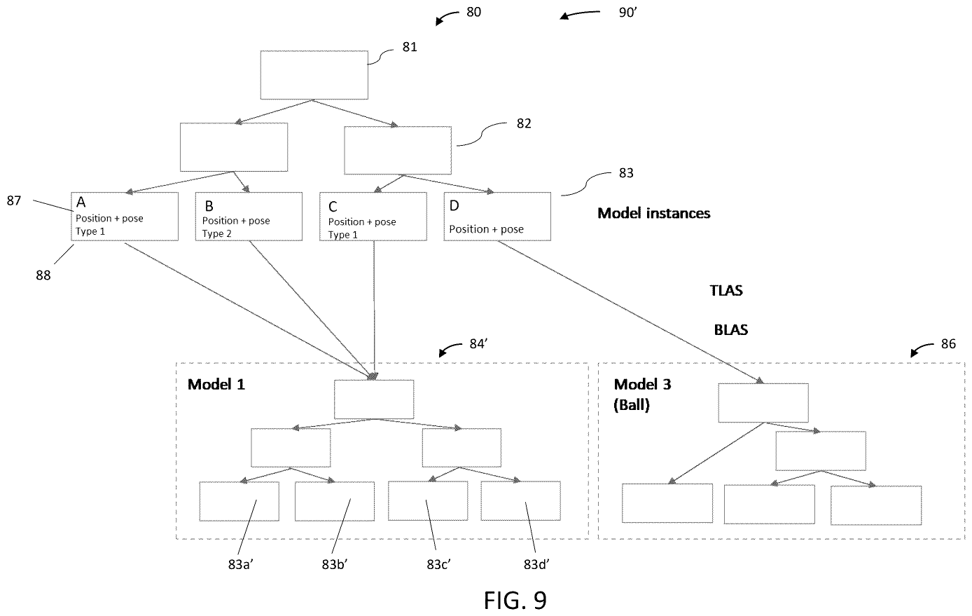

FIG. 9 illustrates another data structure for storing a voxel representation of the scene of FIG. 6 according to an embodiment of the technology described herein.

The data structure 90′ of FIG. 9 is similar to the data structure 90 of FIG. 8. However, instead of storing different object data structures 84, 85 for the different chair objects 51, 51″, one object data structure 84′ represents both different chair objects.

In this regard, object traversal data 88 is provided in the leaf nodes 83 of the voxel data structure 80, which is useable when traversing the object data structure 84′ to determine which of the different chairs is present in the volume represented by the leaf node.

For example, the second chair 51″ includes an additional feature compared to the first chair 51, 51′. The chairs are otherwise identical. Thus, leaf nodes 83b′, 83c′ and 83d′ may contain object data describing the first chair, with leaf node 83a′ including object data for the additional feature of the second chair.

Thus, the object traversal data 88 for chair 51 may indicate (may be used to determine) that (only) leaf nodes 83b′, 83c′ and 83d′ are required for chair 51. However, the object traversal data 88 for chair 51″ may indicate that leaf node 83a′ is also required when processing chair 51″.

By storing only one data structure 84′ that can be used with respect to both different chair objects 51, 51″, the data structure of FIG. 9 provides a further reduction in the amount of object data that is required to be stored, which may allow more of a scene to be stored locally on a device, reducing processing requirements and power consumption.

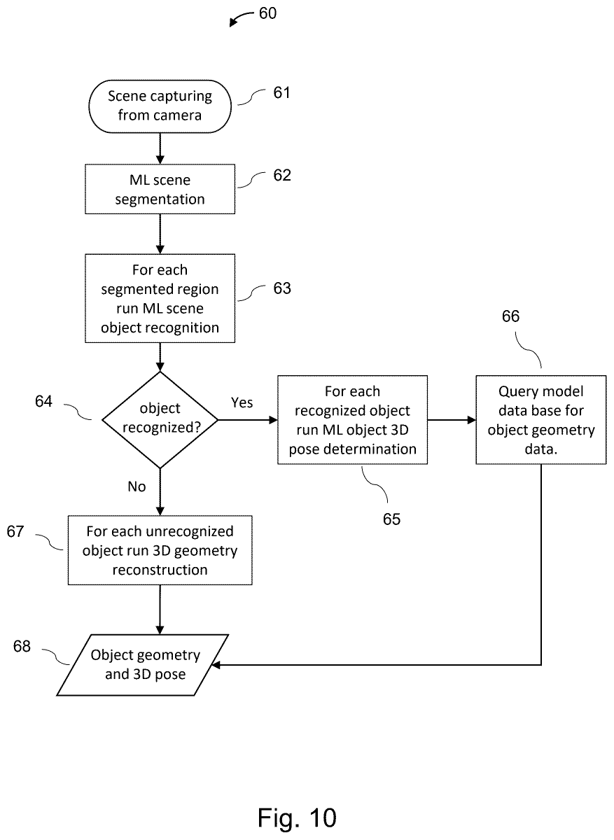

FIG. 10 is a flow chart 60 showing the obtaining of object data for representation in object data structures, in accordance with embodiments of the technology described herein.

A sensor 15 (e.g. a camera) captures 61 data regarding a scene, for example the surroundings of the data processing system. The sensor (e.g. camera) 15 may capture and process single views of the scene, or may capture multiple views of the scene which may be combined (e.g. composited) before further processing occurs.

The one or more views of the scene are then segmented 62, for example using an appropriate machine learning algorithm, to identify regions of the scene that contain objects (for example, by dividing the scene into one or more regions that contain objects, and one or more regions that do not contain objects). Any suitable algorithm (e.g. a machine learning algorithm) can be used for this purpose, as desired.

For each region of the scene that contains an object, a further machine learning algorithm is run 63 to recognise objects in the region. Recognition of an object may, for example, include using machine learning classifiers to (attempt to) determine a class and sub-class of item, for example based on a current view position. Thus, the object recognition may determine what type of object is contained in a region identified as containing objects.

It will be appreciated that, whilst FIG. 10 shows the segmentation 62 of the scene into regions containing objects and recognition 63 of (particular) objects within those regions as two separate steps, it would be equally possible for these steps to be combined, for example by using a single machine learning algorithm that performs both segmentation and recognition.

It will also be appreciated that the object recognition algorithm could use one or more of image data, image and depth data, or voxel data. Furthermore, it will be appreciated that the object recognition algorithm may comprise multiple (different) recognition algorithms, for example operating on different (e.g. types of) data.

For example, initial segmentation of an image may be performed using a computer vision algorithm based, for example, on RGB colour data. For objects that are detected, a class may be determined. A sub-class may (then) be determined by comparing a voxel representation of the object with an existing voxel object model in memory.

When the object recognition algorithm recognises an object 64, a pose of the object in the scene is determined 65. The pose of an object may be determined in any suitable and desired way, for example by using a suitable pose determining algorithm, such as PoseCNN.

It will be appreciated that the determined pose may be an “initial” pose, which may be re-determined and updated (if necessary), for example based on further views of the object, as desired.

Once the pose of the object has been determined, a model database (e.g. stored offline, for example in the cloud, or stored locally in storage 6 of the data processing system) is queried 66 to determine whether the database (already) includes object data for the recognised object. If so, this object data is used with respect to the object, for example by downloading the object data from the database and including the object data in an object data structure, or by including a link to the object data in the database in an object data structure.

If an object is not recognised (or if no data for a recognised object is present in the object database), object data for an object is instead reconstructed 67 from the one or more views of the scene. Object data for the object can be reconstructed from the scene in any suitable and desired way.

When reconstructing object data from a scene, a pose of the object may also be determined, and stored along with the object data. This pose may be defined in any suitable and desired way.

The object data (or a link thereto) along the pose of the object can be (and are) then included in the data structure for representing the scene.

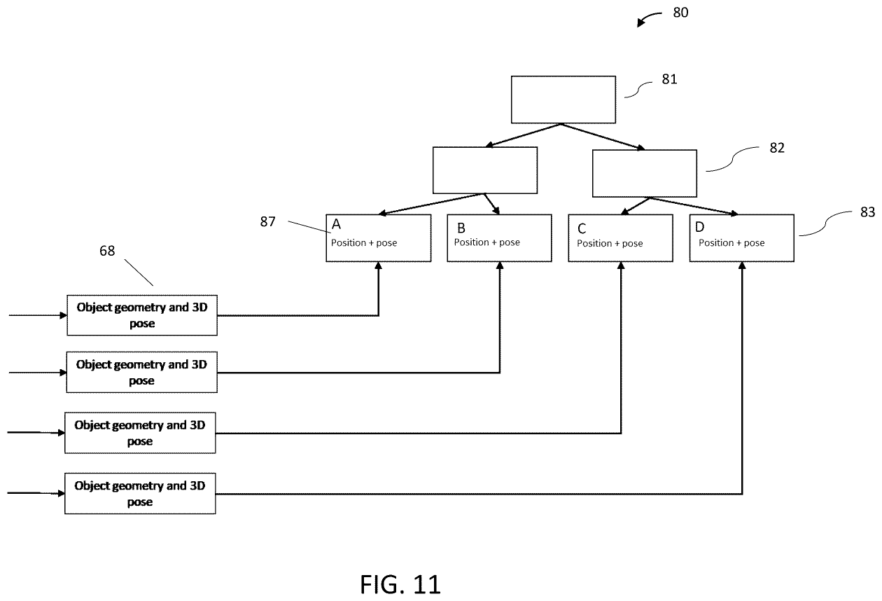

FIG. 11 schematically shows the inclusion of object data and pose in a voxel representation of a scene. The data structure of FIG. 11 may, in some embodiments, be any of the data structures discussed with regards to FIGS. 7 to 9. The data structure shown in FIG. 11 represents the scene shown in FIG. 6, with four objects (A to D).

A voxel data structure 80 describes the scene in scene space. As described above, the voxel data structure comprises multiple sets of nodes 81, 82, 83, which may represent different volumes of a scene. The voxel data structure may be generated in any suitable and desired way, such as in the usual way for the data processing system.

For objects identified within the scene, object geometry and pose data 68 is obtained, for example using the method 60 described with respect to FIG. 10.

The object geometry and pose data 68 is associated with a (each) end (leaf) node 83 of the voxel data structure 80 representing a volume of the scene that contains the object.

In particular, pose data 87 is included in the leaf node 83 of the voxel data structure 80, as well as a position of the object within the volume represented by the leaf node 83.

The object (geometry) data is stored in any suitable and desired way. In some embodiments the object (geometry) data is included (directly) in the appropriate leaf node 83 of the voxel data structure 80. In other embodiments, an appropriate (separate) object data structure is stored, such as the object data structures 84, 84′, 85, 86 of FIGS. 9 and 10, and a pointer to the (separate) object data structure is included in the leaf node 83 of the voxel data structure 80.

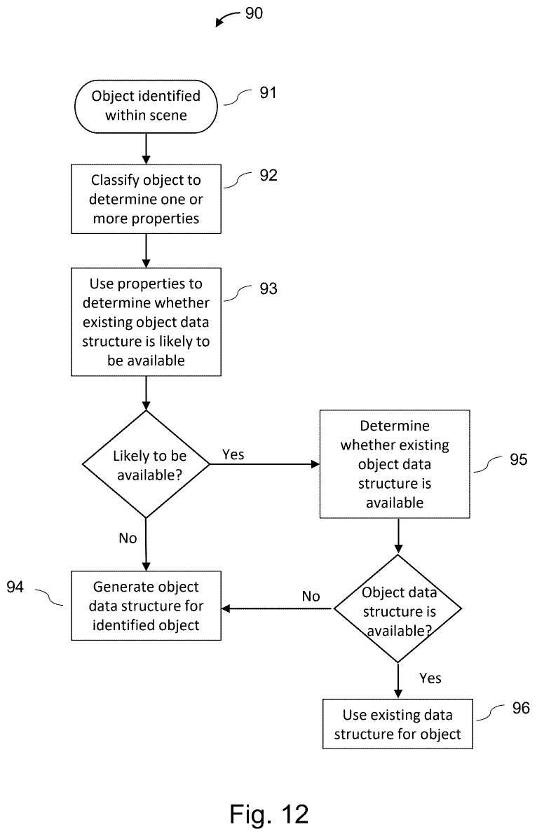

FIG. 12 is a flowchart illustrating a method of representing an identified object in an object data structure, in accordance with an embodiment.

The method 90 of FIG. 12 may, for example, be performed in combination with the object recognition 64 of the method of FIG. 10.

An object is first identified 91 within a scene (e.g. from one or more views of the scene). An object may be identified within the scene in any suitable and desired way, for example by performing segmentation and object recognition as described above.

One or more properties (characteristics) of the object are then determined 92, for example by using an appropriate machine-learning (or other) algorithm to classify the object.

The determined properties are then used to determine whether an existing object data structure for the identified object is likely to be available 93 (for example in a previously stored object data structure local to the device, or in a database of object data structures stored in the cloud).

The one or more properties that are determined may be any suitable or desired properties that can be used to ascertain whether an existing object data structure is likely to be available. In this regard, the properties may generally be indicative of the likelihood that the object is unique. For example, the identified object may be classified to determine whether it is any or all of organic, flexible or dynamic. The Applicants have appreciated that such objects are more likely to be unique, and so are unlikely to be matched to an existing object data structure.

Other suitable and desired properties may, of course, be used as desired.

When the identified object is determined, based on the one or more properties, to be not likely to be available in an existing object data structure, a data structure is generated 94 for the identified object, for example by using one or more views of the scene.

When the identified object is determined to be likely to be available in an existing data structure, it is then determined whether an existing object data structure is (actually) available for the object 95. For example, the identified object may be compared to existing object data structures to determine whether the object is similar or identical, as described above.

In some embodiments, the existing object data structures that the identified object is compared to may be object data structures stored as part of an existing voxel representation (for example for previously identified objects). Additionally or alternatively, the identified object may be compared against a database of object data structures, which may be stored either locally on the device or in the cloud.

When it is determined that an existing object data structure is available for the identified object, the (existing) object data structure is then used for the object 96 in the representation of the scene. For example, the (existing) object data structure may be (and is in an embodiment) associated with one or more end nodes of a voxel data structure, as described above.

Where the existing object data structure is stored in a database stored in the cloud, using the existing object data structure for the object may include downloading the object data structure from the cloud.

When it is instead determined that an existing object data structure is not available for an identified object, an object data structure is generated for the identified object 94, as described above.

In this regard, the Applicants have appreciated that comparing identified objects to existing object data structures may be relatively computationally intensive. Thus, the Applicants have appreciated that processing resources can be saved by (only) comparing identified objects to existing object data structures when there is a relatively high likelihood that an existing object data structure will indeed exist, for example when properties (characteristics) of an object indicate that it is not likely to be unique.

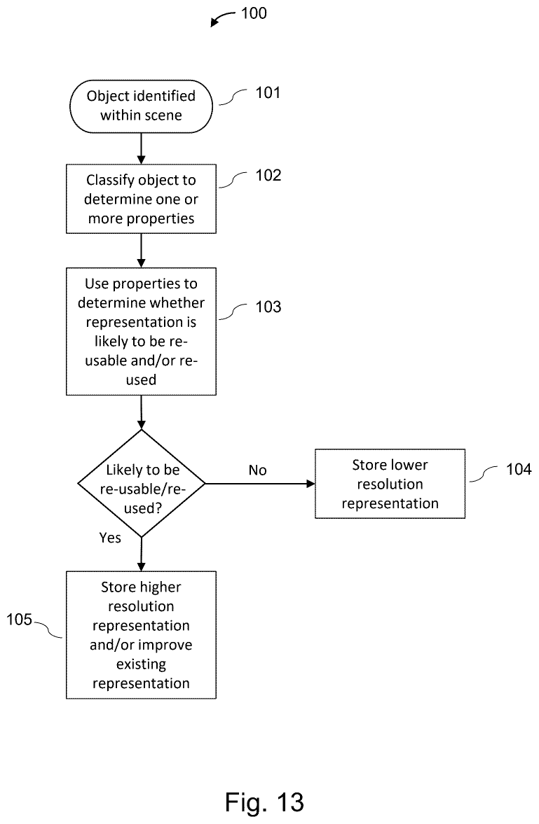

FIG. 13 is a flowchart illustrating a method of representing an identified object in an object data structure, in accordance with an embodiment.

The method 100 of FIG. 13 is similar to the method 90 of FIG. 12, and may be used in combination therewith as desired.

As in the method 90 of FIG. 12, the method 100 of FIG. 13 starts with an object identified within the scene 101. One or more properties (characteristics) of the object are then identified 102.

The one or more properties are then used to determine whether representation of the identified object is likely to be re-usable and/or re-used 103.

The determined properties may be any suitable or desired properties that can be used to identify whether an object data structure for an object is likely to be re-usable and/or re-used. For example, the determined properties may be any or all of the properties described above with regard to FIG. 12.

In this regard, the Applicants have appreciated that many properties of an object within a scene can be indicative of whether or not an object data structure is likely to be re-usable. For example, organic, flexible and/or dynamic objects are likely to change with time, and are likely to be unique, and so are unlikely to be re-usable/re-used, whilst rigid, static, non-organic objects may be more likely to appear more than once in a scene, or to be present (in the same form) in future scenes.

For objects that are determined to be likely to be re-usable/re-used, a higher resolution representation of the object is stored 105, for example by obtaining and integrating a larger number of views of the scene. Additionally or alternatively, an existing representation of the identified object may be improved 105, for example by combining (integrating) data for the object from one or more views of the scene with the existing representation.

When it is determined that an object is not likely to be re-used, a lower resolution image is stored 104, for example by using fewer views of the scene to generate the representation.

In this regard, the Applicants have appreciated that analysing and integrating (combining) data from different views of the scene to generate object data structures may be computationally intensive. As such, the Applicants have identified that processing resources may be saved by focussing such resources on generating more detailed representations (or further improving existing representations) for objects for which the representation is more likely to be re-used.

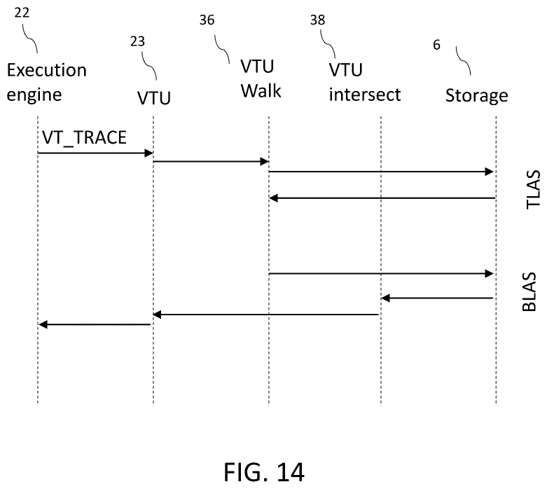

FIG. 14 is a diagram illustrating the various components of the data processing system which are used (and information flow therebetween) when a voxel data structure and a further object data structure are traversed.

As shown in FIG. 14, the execution unit 22 in response to executing an instruction indicating that a traversal is to be performed sends a message (VT_TRACE message) to the traversal unit (VTU) 23. The traversal unit 23 then performs a traversal of the voxel data structure (TLAS) using its walk unit 36, until a leaf node associated with a volume (region) of interest is reached.

The volume (region) of interest in the scene may correspond, for example with a region of the scene which is being desired to be rendered for display (for example is currently, or expected to be, viewed, for example by a user in the case of an augmented reality application) or otherwise desired to be processed.

The traversal unit may traverse (walk) the hierarchical data structure in any suitable and desired manner to arrive at a leaf node associated with a volume (region) of interest of the scene. For example, the traversal may be performed based on an origin, direction (and optionally a range) to arrive at the region (volume) of interest in the scene. The walk may start at a first (root) node and test whether any volumes of its respective child nodes are of interest (are ‘intersected’ for the origin and direction for the traversal question), and then for any (child) node which was determined to be of interest (is intersected) to then determine whether any volume of its respective child nodes are of interest (are ‘intersected’), and so on until a leaf node is reached (or until the range into the scene is reached, if that occurs sooner). Such a walk may be performed in a similar way to a traversal of a ray tracing acceleration data structure, in which a ‘ray’ with an origin and direction is cast through the acceleration data structure.

When performing the traversal (walk), the walk unit 36 tests whether node volumes of the voxel data structure are intersected (e.g. according to the origin and direction for the walk as discussed above). Information identifying the volumes associated with nodes of the hierarchical data structure may be obtained by the walk unit 36 (and stored in walk cache 39) as and when required from storage of the data processor (such as from main memory 6, for example obtained via appropriate interconnects and cache hierarchy discussed with respect to FIGS. 1 to 4).

However, as shown in FIG. 14 upon reaching a leaf node and determining that a (further) object data structure (bottom level acceleration data structure (BLAS)) is to be traversed, the walk unit 36 then traverses the relevant object data structure, until a leaf node 83′ is reached.

If the leaf node 83′ comprises voxel data indicating voxel properties (is not empty), the intersect unit 38 determines whether a voxel falling within the leaf node volume is actually of interest (is actually intersected), and if there is an intersect informs the execution unit 22 that the voxel is to be processed.

As will be appreciated from the above, the technology described herein, in its embodiments at least, can provide a voxel representation of a scene with reduced size, which may allow a larger representation to be stored locally to a device, which reduce the power and energy consumption required when using voxel representations. This is achieved, in embodiments of the technology described herein at least, by identifying one or more objects within a scene, and associating an object data structure representing the object with one or more voxels of a voxel data structure representing the scene.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A method of generating a representation of a scene using a set of one or more voxels, the method comprising:
identifying, from one or more views of a scene to be represented using a set of one or more voxels, one or more objects within the scene;
generating a voxel data structure comprising a set of one or more voxels representing the scene; and
for an object identified within the scene:
associating an object data structure representing the object with one or more voxels of the voxel data structure representing the scene.

2. The method of claim 1, wherein the voxel data structure comprises a plurality of nodes representing respective volumes of the scene, the plurality of nodes comprising one or more end nodes that indicate data to be processed for a respective volume of the scene, and one or more nodes that indicate one or more other nodes to be processed for a respective volume of the scene; and
associating an object data structure representing the object with one or more voxels of the voxel data structure comprises including an indicator of the object data structure in an end node of the voxel data structure that comprises the one or more voxels.

3. The method of claim 1, wherein identifying one or more objects within a scene comprises determining whether more than one instance of an object is present within the scene and the method comprises, when it is determined that more than one instance of an object is present within a scene:
associating an object data structure for the object with more than one group of one or more voxels in the voxel data structure.

4. The method of claim 1, wherein the object data structure comprises a plurality of nodes representing respective volumes of the object, the plurality of nodes comprising one or more end nodes that indicate object data to be processed for a respective volume of the object.

5. The method of claim 1, wherein an object data structure comprises a plurality of nodes including a first set of one or more nodes indicating data to be processed for a first object that the object data structure represents, and a second set of one or more nodes indicating data to be processed for a second object that the object data structure represents, wherein one or more nodes are shared between the first set of nodes and the second set of nodes.

6. The method of claim 1, wherein for an object identified within a scene, associating an object data structure representing the object with one or more voxels of a voxel data structure comprises:
determining whether an existing object data structure is available for the identified object; and
when an existing object data structure is available for an object, associating the existing object data structure with one or more voxels for the identified object.

7. The method of claim 6, wherein determining whether an existing object data structure is available for an identified object comprises:
comparing the identified object with one or more representations of objects in an existing object data structure; and
when an object is identified to be identical to a representation of an object in an object data structure, associating the object data structure with one or more voxels comprises including an indication of the representation of the object in the voxel data structure; and
when an object is identified to be similar, but not identical, to a representation of an object in an object data structure:
storing a difference between the representation and the identified object in the object data structure, wherein associating the object structure with one or more voxels comprises including, in the voxel data structure, object traversal data which is usable to obtain the difference from the object data structure.

8. The method of claim 1, wherein identifying one or more objects within the scene comprises:
classifying an identified object to identify one or more properties of the object; and
using the one or more properties of the identified object to determine whether an existing object data structure is likely to be available for the identified object; and
when it is determined that an existing object data structure is not likely to be available for the identified object based on the one or more properties:
generating an object data structure for the identified object without determining whether an existing object data structure is available for the object.

9. The method of claim 1, wherein identifying one or more objects within the scene comprises:
classifying an identified object to identify one or more properties of the object;
using the one or more properties of the identified object to determine whether data for the identified object is likely to be re-usable and/or re-used for the scene and/or for another scene; and
when it is determined that data for the identified object is likely to be re-usable and/or re-used based on the one or more properties of the identified object, using the one or more views of the scene to improve a representation of the object in an existing data structure.

10. The method of claim 1, wherein identifying one or more objects within a scene comprises:
classifying an identified object to identify one or more properties of the object;
using the one or more properties of the identified object to determine whether data for the identified object is likely to be re-usable and/or re-used for the scene and/or for another scene;
when it is determined that data for the identified object is likely to be re-usable and/or re-used based on the one or more properties of the identified object, storing a higher resolution representation of the object in an object data structure; and
when it is when it is determined that the identified object is not likely to be re-usable and/or re-used based on the one or more properties of the identified object, storing a lower resolution representation of the identified object in an object data structure.

11. A method of processing a representation of a scene that uses a set of one or more voxels, wherein the representation of the scene comprises a voxel data structure comprising a set of one or more voxels representing the scene, and in which one or more voxels of the voxel data structure are associated with an object data structure representing an object within the scene, the method comprising:
traversing the voxel data structure to identify a voxel to be processed; and
when the identified voxel to be processed is associated with an object data structure representing an object within the scene:
using the association to determine an object data structure to be used when performing processing for the voxel; and
using the determined object data structure when performing processing for the voxel.

12. The method of claim 11, wherein using the object data structure to perform processing for the voxel comprises using object traversal data to identify a representation of an object in the object data structure, and using the representation of the object when performing processing for the voxel.

13. A data processing system operable to generate a representation of a scene using a set of one or more voxels, the data processing system comprising:
an object identification circuit configured to identify, from one or more views of a scene to be represented using a set of one or more voxels, one or more objects within the scene; and
a voxel data structure generation circuit configured to generate a voxel data structure comprising a set of one or more voxels representing the scene;
wherein the voxel data structure generation circuit is configured to, for an object identified within the scene by the object identification circuit:
associate an object data structure representing the object identified within the scene with one or more voxels of the voxel data structure representing the scene.

14. The data processing system of claim 13, wherein the voxel data structure comprises a plurality of nodes representing respective volumes of the scene, the plurality of nodes comprising one or more end nodes that indicate data to be processed for a respective volume of the scene, and one or more nodes that indicate one or more other nodes to be processed for a respective volume of the scene; and
the voxel data structure generating circuit is configured to, when associating an object data structure representing the object with one or more voxels of the voxel data structure, include an indicator of the object data structure in an end node of the voxel data structure that comprises the one or more voxels.

15. The data processing system of claim 13, wherein the object identification circuit is configured to, when identifying one or more objects within a scene, determine whether more than one instance of an object is present within the scene; and
the voxel data structure generating circuit is configured to, when it is determined that more than one instance of an object is present within a scene:
associate an object data structure for the object with more than one group of one or more voxels in the voxel data structure.

16. The data processing system of claim 13, wherein the object data structure comprises a plurality of nodes representing respective volumes of the object, the plurality of nodes comprising one or more end nodes that indicate object data to be processed for a respective volume of the object.

17. The data processing system of claim 13, wherein an object data structure comprises a plurality of nodes including a first set of one or more nodes indicating data to be processed for a first object that the object data structure represents, and a second set of one or more nodes indicating data to be processed for a second object that the object data structure represents, wherein one or more nodes are shared between the first set of nodes and the second set of nodes.

18. The data processing system of claim 13, wherein the voxel data structure generating circuit is configured to, when associating an object data structure representing an object identified within a scene with one or more voxels of a voxel data structure:
determine whether an existing object data structure is available for the identified object; and
when an existing object data structure is available for an object, associate the existing object data structure with one or more voxels for the identified object.

19. The data processing system of claim 18, wherein the object identification circuit is configured to, when identifying one or more objects within the scene:
classify an identified object to identify one or more properties of the object; and
use the one or more properties of the identified object to determine whether an existing object data structure is likely to be available; and
the data processing system further comprises an object data structure generation circuit configured to, when it is determined that an existing object data structure is not likely to be available for the identified object based on the one or more properties:
generate an object data structure for the identified object without the voxel data structure generating circuit determining whether an existing object data structure is available for the object.

20. A non-transitory computer readable storage medium storing computer software code which when executed on at least one processor, performs a method of generating a representation of a scene using a set of one or more voxels, the method comprising:
identifying, from one or more views of a scene to be represented using a set of one or more voxels, one or more objects within the scene;
generating a voxel data structure comprising a set of one or more voxels representing the scene; and
for an object identified within the scene:
associating an object data structure representing the object with one or more voxels of the voxel data structure representing the scene.
